(19) United States
(12) Patent Application Publication
(10) Pub. No.: US 2020/0109063 A1
(43) Pub. Date: Apr. 9, 2020

(54) CHEMICAL FEED CONTROL DEVICE, WATER TREATMENT SYSTEM, CHEMICAL FEED CONTROL METHOD, AND PROGRAM

(71) Applicant: MITSUBISHI HEAVY INDUSTRIES, LTD., Tokyo (JP)

(72) Inventors: Yuuji NAKAJIMA, Tokyo (JP); Masato KANEDOME, Tokyo (JP); Kazuhisa TAMURA, Tokyo (JP); Masanori FUJIOKA, Yokohama-shi, Kanagawa (JP); Toru TANAKA, Yokohama-shi, Kanagawa (JP); Akihiro HAMASAKI, Yokohama-shi, Kanagawa (JP); Kenji SATO, Tokyo (JP); Yukihiko INOUE, Tokyo (JP); Hideharu TANAKA, Tokyo (JP)

(21) Appl. No.: 16/617,589

(22) PCT Filed: Nov. 30, 2018
(86) PCT No.: PCT/JP2018/044230

§ 371 Date: Nov. 27, 2019

(30) Foreign Application Priority Data
Dec. 1, 2017 (JP) 2017-231727
Dec. 1, 2017 (JP) 2017-231729
Dec. 6, 2017 (JP) 2017-234335
Dec. 6, 2017 (JP) 2017-234554

(51) Int. Cl. C02F 1/00; C02F 1/68

(52) U.S. Cl. CPC C02F 1/008; C02F 1/68; C02F 2303/22; C02F 2303/08; C02F 2209/006

(57) ABSTRACT

A chemical feed control device controls feeding of a chemical into a water system of a plant. A water quality index-obtaining unit obtains a water quality index value for each of a plurality of disruptive factors of the water system. An environmental data-obtaining unit obtains environmental data related to the plant. An operational data-obtaining unit obtains operational data related to the plant. A determination unit determines a feed amount of each of a plurality of chemicals acting on at least one disruptive factor and having components different from each other with respect to the water system based on the water quality index value, the environmental data, and the operational data such that the water quality index value for each of the disruptive factors approximates a water quality target value for each of the disruptive factors.

### TECHNICAL FIELD

The present invention relates to a chemical feed control device, a water treatment system, a chemical feed control method, and a program.

Priority is claimed on Japanese Patent Application No. 2017-231727, filed Dec. 1, 2017, Japanese Patent Application No. 2017-231729, filed Dec. 1, 2017, Japanese Patent Application No. 2017-234335, filed Dec. 6, 2017, and Japanese Patent Application No. 2017-234554, filed Dec. 6, 2017, the contents of which are incorporated herein by reference.

### BACKGROUND ART

In a water system such as a circulating water system in a power plant, chemicals are fed into the water system such that disruption such as corrosion, scaling, or fouling does not occur. Chemicals to be fed into the water system are formulated in advance based on a water quality at the time of worst case conditions of the water system. Accordingly, disruption in the water system can be prevented by feeding a specific first amount of a chemical into the water system and discharging a specific second amount of water from the water system.

Patent Literature 1 discloses a technology of obtaining an optimum supply amount of a reducer to be supplied to a combustion facility. According to the technology described in Patent Literature 1, a central control unit determines a supply amount of the reducer using functions of a state quantity of the combustion facility, operation conditions, and other parameters.

### CITATION LIST

### Patent Literature

[Patent Literature 1]

Published Japanese Translation No. H11-512799 of the PCT International Publication

### SUMMARY OF INVENTION

### Technical Problem

Incidentally, in consideration of reduction in costs and reduction in environmental load, there is demand for reducing the feed amounts of chemicals with to water systems. As in a technology described in Patent Literature 1, there is the possibility that the feed amount of a chemical may be able to be reduced by controlling the feed amount of a chemical based on the state of a water system. Meanwhile, as described above, in a case where a chemical is formulated based on a water quality at the time of worst case conditions, for example, when a minimum amount of a chemical for preventing scaling is fed in, there is a possibility that a component acting on fouling may be added in excess thereto.

An object of the present invention is to provide a chemical feed control device, a water treatment system, a chemical feed control method, and a program, in which a feed amount of a chemical with respect to a water system is rationalized.

### Solution to Problem

According to a first aspect of the present invention, there is provided a chemical feed control device which controls feeding of a chemical into a water system. The chemical feed control device includes a determination unit that determines a feed amount of each of a plurality of chemicals having different components with respect to the water system based on a water quality of water in the water system.

According to a second aspect of the present invention, in the chemical feed control device according to the first aspect, the determination unit may determine the feed amount of each of the plurality of chemicals based on constraints including a combination of prohibited chemicals.

According to a third aspect of the present invention, in the chemical feed control device according to the first or second aspect, at least one of the plurality of chemicals may act on a plurality of disruptive factors of the water system.

According to a fourth aspect of the present invention, in the chemical feed control device according to any of the first to third aspects, the determination unit may determine the feed amount of each of the plurality of chemicals such that costs are reduced.

According to a fifth aspect of the present invention, the chemical feed control device according to the fourth aspect may further include a candidate determination unit that determines a plurality of candidates for the feed amount of each of the plurality of chemicals based on the water quality, and a cost determination unit that determines the cost of each of the plurality of candidates determined by the candidate determination unit, based on a unit cost which is a cost per unit feed amount of each of the chemicals. The determination unit may determine a candidate having a lowest cost of the plurality of candidates as the feed amount of each of the plurality of chemicals.

According to a sixth aspect of the present invention, there is provided a water treatment system including a water system, a plurality of chemical tanks that retain chemicals having different components, a plurality of chemical feed pumps that supply the chemicals retained respectively in the plurality of chemical tanks to the water system, and the chemical feed control device according to any of the first to fifth aspects.

According to a seventh aspect of the present invention, there is provided a chemical feed control method for controlling feeding of a chemical into a water system. The chemical feed control method includes a step of determining a feed amount of each of a plurality of chemicals having different components with respect to the water system based on the water quality of water in the water system.

According to an eighth aspect of the present invention, there is provided a program for causing a computer of a chemical feed control device which controls feeding of a chemical into a water system to execute a step of determining a feed amount of each of a plurality of chemicals having different components with respect to the water system based on the water quality of water in the water system.

### Advantageous Effects of Invention

According to at least one aspect of the foregoing aspects, a feed amount of components constituting a chemical can be rationalized by determining the feed amounts of a plurality of chemicals having different components in accordance with a water quality.

### BRIEF DESCRIPTION OF DRAWINGS

FIG. 1 is a schematic block diagram illustrating a constitution of a water treatment system according to an embodiment.

FIG. 2 is a schematic block diagram illustrating a constitution of a chemical feed control device according to an embodiment.

FIG. 3 is an example of teaching data used for learning of a chemical feed model.

FIG. 4 is a graph showing an example of a load variation model indicating relationships between a water quality index value, plant data, a feed amount of a certain chemical, and a water quality index value after a certain time.

FIG. 5 is a flowchart showing an operation of the chemical feed control device according to an embodiment.

FIG. 6 is a schematic block diagram illustrating a constitution of the chemical feed control device according to an embodiment.

FIG. 7 is a flowchart showing an operation of the chemical feed control device according to an embodiment.

FIG. 8 is a schematic block diagram illustrating a constitution of the chemical feed control device according to an embodiment.

FIG. 9 is a flowchart showing an operation of the chemical feed control device according to an embodiment.

FIG. 10 is a schematic block diagram illustrating a constitution of the chemical feed control device according to an embodiment.

FIG. 11 is a view illustrating an example of a relationship between a standard cost and a total cost.

FIG. 12 is a flowchart showing an operation of the chemical feed control device according to an embodiment.

FIG. 13 is a schematic block diagram illustrating a constitution of a chemical management device according to an embodiment.

FIG. 14 is a flowchart showing an operation of the chemical management device according to an embodiment.

FIG. 15 is a schematic block diagram illustrating a constitution of the water treatment system according to an embodiment.

FIG. 16 is a schematic block diagram illustrating a constitution of a power plant according to an embodiment.

FIG. 17 is a schematic block diagram illustrating a constitution of an auxiliary-machine control device according to an embodiment.

FIG. 18 is a view illustrating an example of a relationship between power of a third water feeding pump and power of a fan.

FIG. 19 is a flowchart showing an operation of the auxiliary-machine control device according to an embodiment.

FIG. 20 is a schematic block diagram illustrating a constitution of the auxiliary-machine control device according to an embodiment.

FIG. 21 is a flowchart showing an operation of the auxiliary-machine control device according to an embodiment.

FIG. 22 is a schematic block diagram illustrating a constitution of the auxiliary-machine control device according to an embodiment.

FIG. 23 is a flowchart showing an operation of the auxiliary-machine control device according to an embodiment.

FIG. 24 is a schematic block diagram illustrating a constitution of the power plant according to an embodiment.

FIG. 25 is a schematic block diagram illustrating a constitution of a state-evaluating device according to an embodiment.

FIG. 26 is a view illustrating an example of a rated performance function.

FIG. 27 is a flowchart showing an operation of the state-evaluating device according to an embodiment.

FIG. 28 is a schematic block diagram related to a constitution of the state-evaluating device according to an embodiment.

FIG. 29 is a flowchart showing an operation of the state-evaluating device according to an embodiment.

FIG. 30 is a view of an overall constitution of a thermal power plant of a twelfth embodiment.

FIG. 31 is a view of an overall constitution of a thermal power plant of a thirteenth embodiment.

FIG. 32 is a view of an overall constitution of a thermal power plant of a fourteenth embodiment.

FIG. 33 is a view of an overall constitution of a thermal power plant according to a first modification example of the fourteenth embodiment.

FIG. 34 is a view of an overall constitution of a thermal power plant according to a second modification example of the fourteenth embodiment.

FIG. 35 is a view of an overall constitution of a thermal power plant according to a fifteenth embodiment.

FIG. 36 is a view of an overall constitution of a thermal power plant according to a modification example of the fifteenth embodiment.

FIG. 37 is a schematic block diagram illustrating a constitution of a computer according to at least one embodiment.

### DESCRIPTION OF EMBODIMENTS

### First Embodiment

Hereinafter, embodiments will be described in detail with reference to the drawings.

<<Constitution of Water Treatment System>>

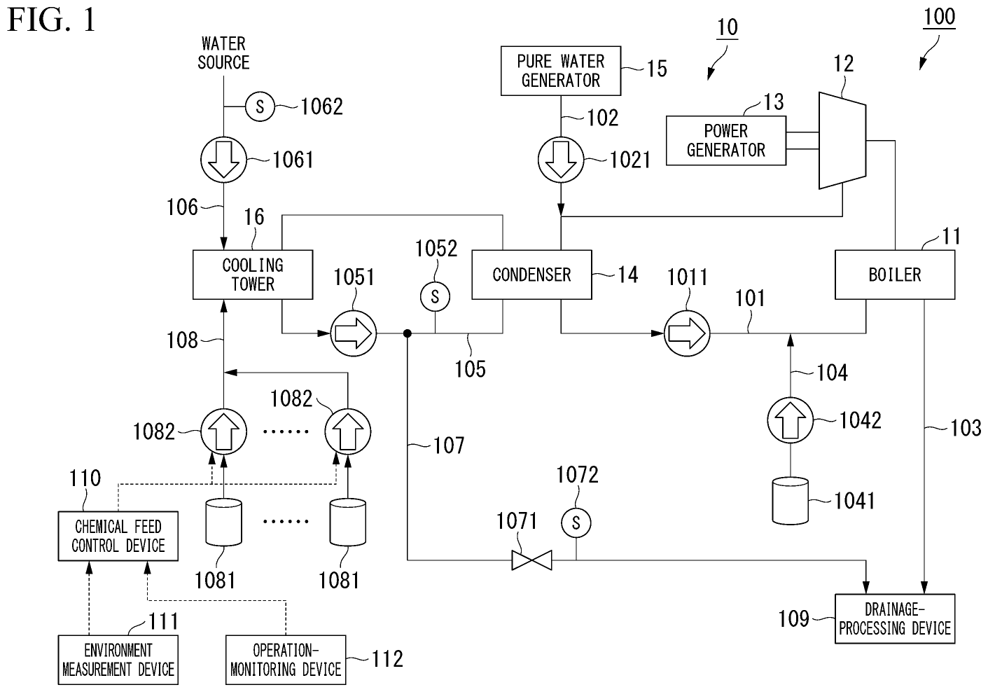

FIG. 1 is a schematic block diagram illustrating a constitution of a water treatment system according to an embodiment.

A water treatment system 100 according to a first embodiment is provided in a power plant 10. In the water treatment system 100, a plurality of disruptive factors (for example, corrosion, scaling, or fouling) caused in a circulating water system is curbed by feeding a chemical into the circulating water system of the power plant 10.

The power plant 10 includes a boiler 11, a steam turbine 12, a power generator 13, a condenser 14, a pure water generator 15, and a cooling tower 16.

The boiler 11 generates steam by evaporating water. The steam turbine 12 rotates due to steam generated by the boiler 11. The power generator 13 converts rotation energy of the steam turbine 12 into electric power. The condenser 14 performs heat exchange between steam discharged from the steam turbine 12 and cooling water, such that the steam returns to water. The pure water generator 15 generates pure water. The cooling tower 16 cools the cooling water subjected to heat exchange in the condenser 14.

The water treatment system 100 includes a steam circulating line 101, a first supply line 102, a first drainage line 103, a first chemical feed line 104, a cooling water circulating line 105, a second supply line 106, a second drainage line 107, a second chemical feed line 108, a drainage-processing device 109, a chemical feed control device 110, an environment measurement device 111, and an operation-monitoring device 112.

The steam circulating line 101 is a line for causing water and steam to circulate in the steam turbine 12, the condenser 14, and the boiler 11. A first water feeding pump 1011 is provided between the condenser 14 and the boiler 11 in the steam circulating line 101. The first water feeding pump 1011 pressure-feeds water from the condenser 14 toward the boiler 11.

The first supply line 102 is a line for supplying pure water generated by the pure water generator 15 to the steam circulating line 101. A second water feeding pump 1021 is provided in the first supply line 102. The second water feeding pump 1021 is used at the time of filling the condenser 14 with water. During operation, water inside the first supply line 102 is pressure-fed from the pure water generator 15 toward the condenser 14 due to decompression of the condenser 14.

The first drainage line 103 is a line for discharging a part of water circulating in the steam circulating line 101 from the boiler 11 to the drainage-processing device 109.

The first chemical feed line 104 is a line for supplying a chemical such as a corrosion preventive agent, a scaling preventive agent, or a slime control agent to the steam circulating line 101. The first chemical feed line 104 includes a first chemical tank 1041 retaining a chemical, and a first chemical feed pump 1042 supplying the chemical from the first chemical tank 1041 to the steam circulating line 101.

The cooling water circulating line 105 is a line for causing the cooling water to circulate in the condenser 14 and the cooling tower 16. A third water feeding pump 1051 and a circulating water quality sensor 1052 are provided in the cooling water circulating line 105. The third water feeding pump 1051 pressure-feeds the cooling water from the cooling tower 16 toward the condenser 14. The circulating water quality sensor 1052 detects a water quality of the cooling water circulating in the cooling water circulating line 105. Examples of the water quality detected by a sensor include an electrical conductivity, a pH value, a salt concentration, a metal concentration, a chemical oxygen demand (COD), a biochemical oxygen demand (BOD), a microbial concentration, a silica concentration, and combinations of these. The circulating water quality sensor 1052 outputs a circulating water quality index value indicating the detected water quality to the chemical feed control device 110.

The second supply line 106 is a line for supplying raw water taken from a water source to the cooling water circulating line 105 as makeup water. A fourth water feeding pump 1061 and a makeup water quality sensor 1062 are provided in the second supply line 106. The fourth water feeding pump 1061 pressure-feeds the makeup water from the water source toward the cooling tower 16. The makeup water quality sensor 1062 outputs a makeup water quality index value indicating the detected water quality to the chemical feed control device 110.

The second drainage line 107 is a line for discharging a part of water circulating in the cooling water circulating line 105 to the drainage-processing device 109. A blow valve 1071 and a drainage water quality sensor 1072 are provided in the second drainage line 107. The blow valve 1071 restricts the amount of drainage water to be blown from the cooling water circulating line 105 to the drainage-processing device 109. The drainage water quality sensor 1072 detects the water quality of the drainage water discharged from the second drainage line 107. The drainage water quality sensor 1072 outputs a drainage water quality index value indicating the detected water quality to the chemical feed control device 110.

The second chemical feed line 108 is a line for supplying a chemical to the cooling water circulating line 105. The second chemical feed line 108 includes a plurality of second chemical tanks 1081 retaining chemicals of different kinds, and a plurality of second chemical feed pumps 1082 supplying a chemical from each of the second chemical tanks 1081 to the cooling water circulating line 105. The chemicals retained respectively in the plurality of second chemical tanks 1081 are chemicals acting on at least one of the plurality of disruptive factors. That is, the chemicals function as any of a corrosion preventive agent, a scaling preventive agent, and a slime control agent.

The drainage-processing device 109 feeds an acid, an alkali, a flocculant, or other chemicals into the drainage water discharged from the first drainage line 103 and the second drainage line 107. The drainage-processing device 109 discards the drainage water processed using the chemical.

The chemical feed control device 110 determines power of the fourth water feeding pump 1061, an opening degree of the blow valve 1071, and feed amounts (stroke amounts or the numbers of strokes of a plunger) of the second chemical feed pumps 1082 based on the water qualities detected by the circulating water quality sensor 1052, the makeup water quality sensor 1062, and the drainage water quality sensor 1072, and environmental data around the power plant 10 measured by the environment measurement device 111.

The environment measurement device 111 measures the environment around the power plant 10 and generates environmental data. Examples of the environmental data include the climate, the temperature, and the humidity of the surrounding area of the power plant 10; and the water quality (turbidity level or the like) of the makeup water. The operation-monitoring device 112 measures operational data of the power plant 10 and generates operational data. Examples of the operational data include an output of the power plant 10, various kinds of flow rates (steam, water, cooling water, chemicals, or the like), the temperature and the pressure of the boiler, the cooling water temperature, and the air volume of a cooling tower.

<<Regarding Chemicals>>

As described above, in each of the second chemical tanks 1081, a chemical acting on at least one of the plurality of disruptive factors of the cooling water circulating line 105 (circulating water system) is retained.

Examples of the chemical include a corrosion preventive agent, a scaling preventive agent, and a slime control agent. Examples of the corrosion preventive agent include phosphate, phosphonate, divalent metal salt, a carboxylic acid-based low molecular weight polymer, nitrite, chromate, and amines/azoles. Examples of the scaling preventive agent include a hydrochloric acid, a sulfuric acid, a phosphonic acid, and an acidic polymer. Examples of the slime control agent include hypochlorite, chloramine, and a halogen compound.

It is preferable that the chemicals retained in the second chemical tanks 1081 be undiluted solutions of chemicals consisting of a single component. A chemical consisting of multiple components may include a component, such as a stabilizing agent, a pH conditioner, or a solvent, which does not act on disruptive factors. Therefore, it is possible to reduce the feed amount of components which do not act on disruptive factors by using undiluted solutions of chemicals consisting of a single component. In addition, the corrosion preventive agent may be a mixture of phosphate, phosphonate, divalent metal salt, a carboxylic acid-based low molecular weight polymer, nitrite, chromate, amines/azoles, and the like retained respectively in the different chemical tanks. The scaling preventive agent may be a mixture of a hydrochloric acid, a sulfuric acid, a phosphonic acid, an acidic polymer, and the like retained respectively in the different chemical tanks. The slime control agent may be a mixture of hypochlorite, chloramine, a halogen compound, and the like retained respectively in the different chemical tanks.

<<Constitution of Chemical Feed Control Device>>

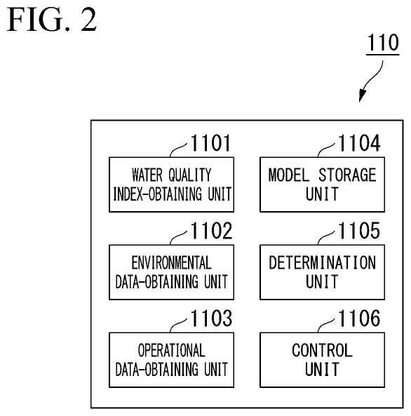

FIG. 2 is a schematic block diagram illustrating a constitution of a chemical feed control device according to an embodiment.

The chemical feed control device 110 according to the first embodiment includes a water quality index-obtaining unit 1101, an environmental data-obtaining unit 1102, an operational data-obtaining unit 1103, a model storage unit 1104, a determination unit 1105, and a control unit 1106.

The water quality index-obtaining unit 1101 obtains a water quality index value indicating the water quality from the circulating water quality sensor 1052, the makeup water quality sensor 1062, and the drainage water quality sensor 1072. The water quality index-obtaining unit 1101 obtains the circulating water quality index value from the circulating water quality sensor 1052, obtains the makeup water quality index value from the makeup water quality sensor 1062, and obtains the drainage water quality index value from the drainage water quality sensor 1072. All of the circulating water quality index value, the makeup water quality index value, and the drainage water quality index value include an index value related to corrosion, an index value related to scaling, and an index value related to fouling. Examples of the index value include an electrical conductivity, a pH value, a salt concentration, a metal concentration, a COD, a BOD, a microbial concentration, and a silica concentration. Among these, the electrical conductivity, the pH value, the salt concentration, and the metal concentration are examples of the index value related to scaling. The COD, the BOD, and the microbial concentration are examples of the index value related to fouling. The pH value is an example of the index value related to corrosion. On the other hand, the examples of each of the index values described above may affect each of the plurality of disruptive factors instead of affecting only one disruptive factor. For example, even if the electrical conductivities are the same values, the level of a risk of scaling may vary depending on the value of the COD.

The environmental data-obtaining unit 1102 obtains the environmental data (the climate, the temperature, the humidity, the water quality of the makeup water, and the like) around the power plant 10 from the environment measurement device 111 as plant data.

The operational data-obtaining unit 1103 obtains the operational data (an output of the power plant 10, the temperature and the pressure of the boiler, and the like) of the power plant 10 from the operation-monitoring device 112 as the plant data.

The model storage unit 1104 stores a chemical feed model for inputting each water quality index value and each piece of the plant data (the environmental data and the operational data) and outputting the feed amount of each chemical.

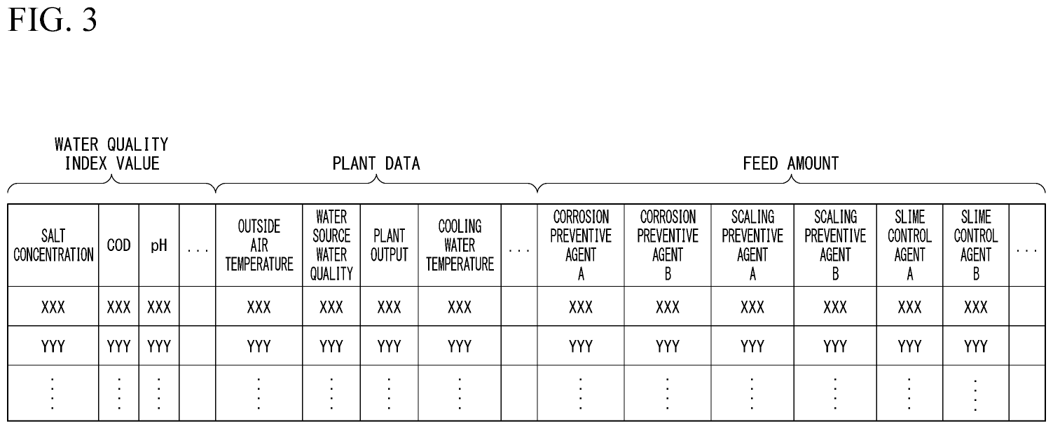

For example, the chemical feed model is a machine learning model such as a neural network. The chemical feed model is a model in which a combination of each water quality index value, the plant data, and the feed amount of each chemical at this time is learned in advance as teaching data. FIG. 3 is an example of teaching data used for learning of a chemical feed model. For example, the teaching data is made in advance by a technician. In addition, the teaching data may be generated automatically from known information. For example, when a load variation model expressing relationships between the water quality index value, the plant data, and the water quality index value after a certain time is obtained in advance through machine learning or the like, the teaching data can be generated automatically based on a known relationship between the water quality index value and the feed amount of each chemical, and the load variation model. Specifically, the water quality index value and the plant data are obtained using random numbers, and the water quality index value after a certain time is acquired by inputting these to the load variation model. Then, the feed amount of each chemical with respect to the water quality index value is obtained by applying a known calculation formula, and thus a combination of the water quality index value, the plant data, and the feed amount of each chemical can be acquired.

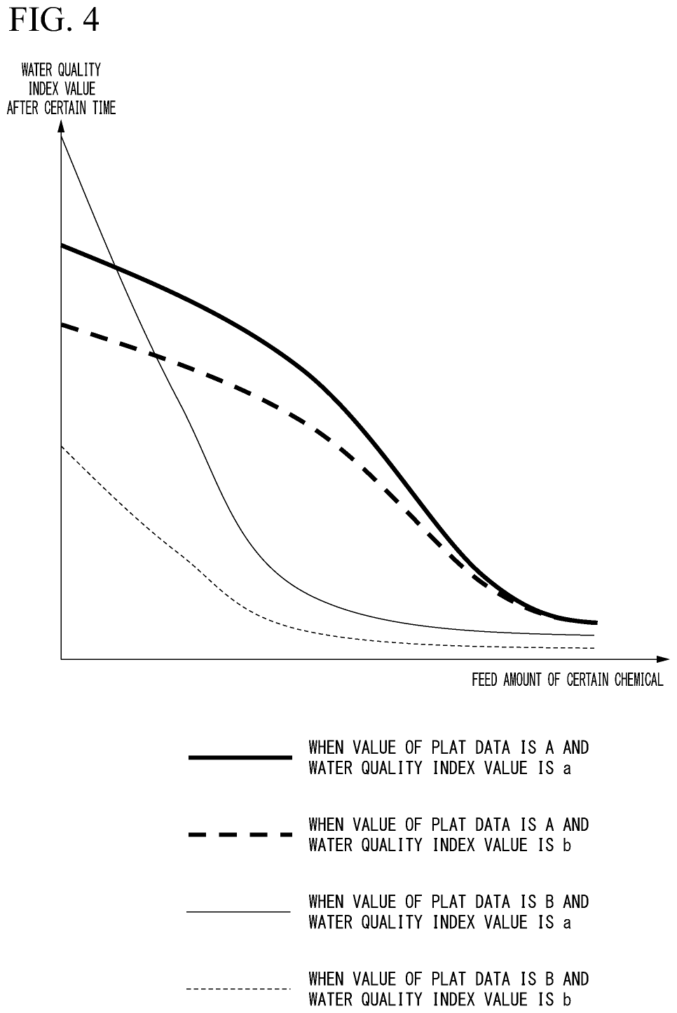

FIG. 4 is a graph showing an example of a load variation model indicating relationships between a water quality index value, plant data, a feed amount of a certain chemical, and a water quality index value after a certain time. In a case where the load variation model illustrated in FIG. 4 is known, when the water quality index value and the value of the plant data are given, it is possible to determine the feed amount of a certain chemical necessary to reduce the water quality index value after a certain time (that is, a risk after a certain time) to a certain value or smaller. That is, a necessary feed amount of a chemical can be acquired by determining the plant data and the water quality index value using random numbers and substituting these into the load variation model. Accordingly, it is possible to automatically generate teaching data which is a combination of the water quality index value, the plant data, and the feed amount of a chemical using the load variation model.

The determination unit 1105 determines the feed amount of each chemical by substituting each water quality index value obtained by the water quality index-obtaining unit 1101, the environmental data obtained by the environmental data-obtaining unit 1102, and the operational data obtained by the operational data-obtaining unit 1103 into the chemical feed model stored in the model storage unit 1104. Accordingly, the determination unit 1105 can determine the feed amount of each of the plurality of chemicals with respect to the water system such that the water quality index value for each of the disruptive factors approximates a water quality target value for each of the disruptive factors.

The control unit 1106 outputs a control command to each of the second chemical feed pumps 1082 based on the feed amount determined by the determination unit 1105.

<<Operation of Chemical Feed Control Device>>

Next, an operation of the chemical feed control device 110 according to the present embodiment will be described.

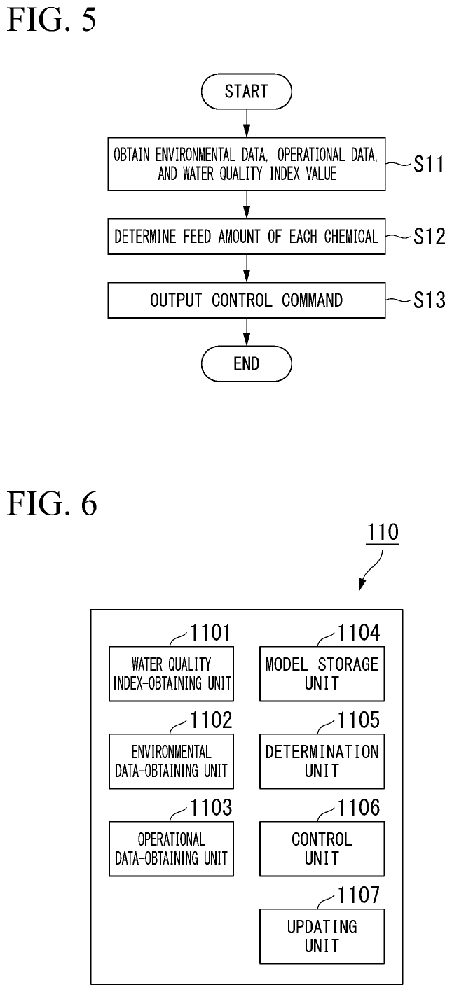

FIG. 5 is a flowchart showing an operation of the chemical feed control device according to an embodiment.

When the chemical feed control device 110 is started, the chemical feed control device 110 executes the following processing at certain time intervals.

The water quality index-obtaining unit 1101 obtains the water quality index value indicating the water quality from the circulating water quality sensor 1052, the makeup water quality sensor 1062, and the drainage water quality sensor 1072. In addition, the environmental data-obtaining unit 1102 obtains the environmental data from the environment measurement device 111. Similarly, the operational data-obtaining unit 1103 obtains the operational data from the operation-monitoring device 112 (Step S111).

Next, the determination unit 1105 determines the feed amount of each chemical by substituting the water quality index value, the environmental data, and the operational data into the chemical feed model stored in the model storage unit 1104 (Step S12). Further, the control unit 1106 outputs a control command to each of the second chemical feed pumps 1082 based on the feed amount determined by the determination unit 1105 (Step S13).

<<Operations and Effects>>

In this manner, according to the first embodiment, the chemical feed control device 110 determines the feed amount of each of a plurality of chemicals having different components with respect to the water system based on the water quality index value for each of the disruptive factors of water in the cooling water circulating line 105 (circulating water system). Accordingly, compared to a case where the water quality is adjusted using a formulated chemical of one kind, it is possible to reduce the amount of components acting on each of the plurality of disruptive factors to a minimum necessary amount.

That is, when a chemical of one kind in which the corrosion preventive agent, the scaling preventive agent, and the slime control agent are combined at a specific ratio is used, the feed amount of the chemical is determined depending on the disruptive factor having the highest risk. For example, in a case where a chemical of one kind is used, when a corrosion risk is high and a scaling risk is low, the feed amount of the chemical is determined focusing on the corrosion risk. Therefore, even though the scaling risk is low, a large amount of the scaling preventive agent is fed in.

On the other hand, according to the first embodiment, the chemical feed control device 110 determines the feed amount of each of a plurality of chemicals having different components, so that a minimum feed amount of each of the chemicals corresponding to each of the disruptive factors can be determined. For example, according to the first embodiment, the feed amounts of the corrosion preventive agent and the scaling preventive agent can differ from each other. Therefore, when the corrosion risk is high and the scaling risk is low, the chemical feed control device 110 can prevent a large amount of the scaling preventive agent from being fed in.

### Second Embodiment

Depending on the kinds of chemical, there are chemicals inducing a disruptive factor when they are mixed with another particular chemical. For example, there are combinations of chemicals which generate precipitates when mixed and contribute to generation of scaling. Therefore, it is preferable that the chemical feed control device 110 determine the feed amount of each chemical in a manner avoiding such combinations of chemicals.

In consideration of this, the chemical feed control device 110 according to a second embodiment determines the feed amount of each of a plurality of chemicals based on constraints including a combination of prohibited chemicals.

The constitution of the chemical feed control device 110 according to the second embodiment is similar to that of the first embodiment.

On the other hand, a method for learning a chemical feed model stored in the model storage unit 1104 differs from that of the first embodiment. Specifically, in a chemical feed model according to the second embodiment, a penalty based on the constraints are added in a learning process.

In a general neural network model, an output value (provisional output value) acquired from an input value included in the teaching data and an output value (correct output value) included in the teaching data are compared to each other. Then, a penalty value (regression penalty value) is calculated such that it becomes larger when the difference therebetween increases, and learning is performed to minimize the penalty value.

In contrast, in the process of learning the chemical feed model according to the second embodiment, in addition to the regression penalty value, a constraint penalty value based on the constraints is calculated, and learning is performed such that the sum of the regression penalty value and the constraint penalty value becomes the minimum. For example, when the provisional output value does not satisfy the constraints (when the feed amount related to combinations of chemicals included in the constraints is equal to or more than a certain amount, or the like), the constraint penalty value takes a positive number, and when the provisional output value satisfies the constraints, it is zero. The output value included in the teaching data satisfies the constraints.

Accordingly, the chemical feed model according to the second embodiment outputs the feed amount of each of the plurality of chemicals based on the constraints. Therefore, the determination unit 1105 can determine the feed amount of each of the plurality of chemicals based on the constraints and the feed amount of each of the plurality of chemicals with respect to the water system using the chemical feed model such that the water quality index value for each of the disruptive factors approximates the water quality target value for each of the disruptive factors.

<<Operations and Effects>>

In this manner, the chemical feed control device 110 according to the second embodiment determines the feed amount of each of a plurality of chemicals based on the constraints including a combination of prohibited chemicals. Accordingly, the chemical feed control device 110 can curb feeding of a chemical related to a combination inducing a disruptive factor.

<<Modification Example>>

In the chemical feed control device 110 according to the second embodiment, learning is performed in consideration of the constraints during the process of learning the chemical feed model, but it is not limited thereto in other embodiments. For example, the determination unit 1105 according to other embodiments may generate candidates for the feed amounts of a plurality of chemicals based on the chemical feed model and determine a candidate satisfying the constraints among these.

### Third Embodiment

Depending on the kinds of chemical, there are chemicals offsetting or synergizing an effect when they are mixed with another particular chemical. Therefore, when a combination offsetting the effect is avoided and a combination synergizing the effect is employed, there is a possibility that the cost may be able to be reduced compared to a case where one chemical is fed into the cooling water circulating line 105.

In addition, depending on the kinds of chemical, there are chemicals acting on two or more disruptive factors with a single component, or chemicals acting on one disruptive factor and inducing another disruptive factor as a side-effect. For example, when a chemical A (particularly, a chemical consisting of a single component) acts on corrosion and scaling, if the chemical is fed into the cooling water circulating line 105, there is a possibility that the cost may be able to be reduced compared to a case where a chemical B acting as a corrosion preventive agent and a chemical C acting as a scaling preventive agent are individually fed into the cooling water circulating line 105.

In addition, for example, in a case where a chemical D which acts on scaling and may induce corrosion is less expensive than a chemical E which acts on scaling but does not induce corrosion, when a risk of corrosion is sufficiently small, there is a possibility that the cost may be able to be reduced by reducing the feed amount of the chemical E and increasing the feed amount of the chemical D.

Meanwhile, synergy or anti-synergy of combinations of chemicals, a side-effect of a single component, and degrees of these are not necessarily known. Accordingly, when the chemical feed control device 110 feeds a plurality of chemicals in accordance with the chemical feed model, there is a possibility of a gap between the water quality after a certain time and a target water quality. In consideration of this, the chemical feed control device 110 according to a third embodiment updates the chemical feed model based on the water quality after a certain time.

<<Constitution of Chemical Feed Control Device>>

FIG. 6 is a schematic block diagram illustrating a constitution of the chemical feed control device according to an embodiment.

The chemical feed control device 110 according to the third embodiment further includes an updating unit 1107, in addition to the constituents of the first embodiment as illustrated in FIG. 6.

The updating unit 1107 updates the chemical feed model stored in the model storage unit 1104 such that the difference between the water quality obtained by the water quality index-obtaining unit 1101 after a certain time of a control command output by the control unit 1106 and the target water quality of the cooling water circulating line 105 is reduced.

<<Operation of Chemical Feed Control Device>>

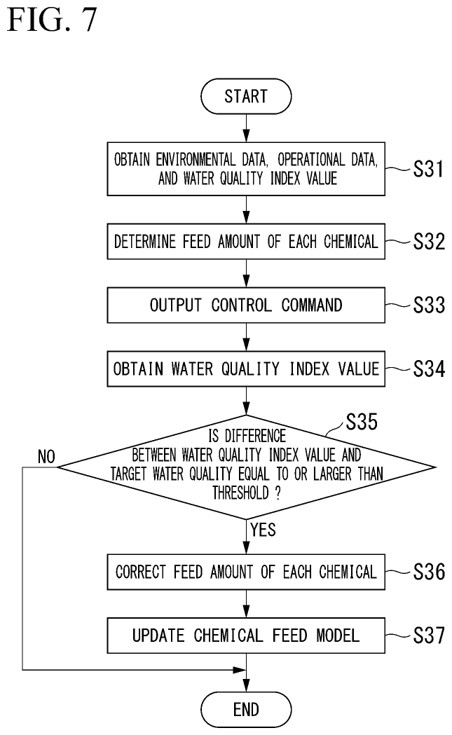

FIG. 7 is a flowchart showing an operation of the chemical feed control device according to an embodiment.

Each of the water quality index-obtaining unit 1101, the environmental data-obtaining unit 1102, and the operational data-obtaining unit 1103 obtains the water quality index value, the environmental data, and the operational data (Step S31). Next, the determination unit 1105 determines the feed amount of each chemical by substituting the water quality index value, the environmental data, and the operational data into the chemical feed model stored in the model storage unit 1104 (Step S32). The control unit 1106 outputs a control command to each of the second chemical feed pumps 1082 based on the feed amount determined by the determination unit 1105 (Step S33).

After a certain time has elapsed from when the control unit 1106 has output the control command, the water quality index-obtaining unit 1101 obtains the water quality index value again (Step S34). The updating unit 1107 determines whether or not a difference between the water quality index value (actual index value) obtained in Step S31 and the water quality index value (target index value) related to the target water quality is equal to or larger than a specific threshold (Step S35). When the chemical feed model is appropriately learned, the actual index value indicates substantially the same value as the target index value. That is, when the difference between the actual index value and the target index value is equal to or larger than the threshold, there is a possibility that learning of the chemical feed model may become insufficient.

When the difference between the actual index value and the target index value is equal to or larger than the threshold (Step S35: YES), the updating unit 1107 corrects the feed amount of the chemical determined by the determination unit 1105 in Step S32, based on the difference between the actual index value and the target index value (Step S36). For example, when the actual index value related to scaling is larger than the target index value, the updating unit 1107 increases the feed amount of the chemical mainly acting on scaling in accordance with the difference between the actual index value and the target index value. On the other hand, when the actual index value related to scaling is smaller than the target index value, the updating unit 1107 reduces the feed amount of the chemical mainly acting on scaling in accordance with the difference between the actual index value and the target index value. The same applies to other disruptive factors such as corrosion and fouling.

The updating unit 1107 updates the chemical feed model stored in the model storage unit 1104 based on the water quality index value, the environmental data, and the operational data obtained in Step S31, and the feed amount corrected in Step S36 (Step S37). For example, when the chemical feed model is a neural network, the updating unit 1107 updates the chemical feed model through back propagation based on the water quality index value, the environmental data, and the operational data; and the feed amount corrected in Step S36. On the other hand, when the difference between the actual index value and the target index value is smaller than the threshold (Step S35: NO), the updating unit 1107 does not update the chemical feed model.

<<Operations and Effects>>

In this manner, the chemical feed control device 110 according to the third embodiment updates the chemical feed model based on the water quality after a certain time. Accordingly, the chemical feed control device 110 can control the feed amount of the chemical by adding synergy or anti-synergy of combinations of chemicals or the influence of side-effects of chemicals. Hereinafter, with the third embodiment, the reason why the feed amounts of chemicals can be controlled by adding synergy, anti-synergy, and the influence of a side-effects will be described.

When there is synergy of combinations of chemicals, there is a possibility that the feed amount of the chemical determined based on the chemical feed model may be excessively large. In this case, since the water quality after a certain time is in a more favorable state than the target water quality, the updating unit 1107 revises down the feed amount determined by the determination unit 1105 and updates the chemical feed model. Accordingly, when there is synergy of combinations of chemicals, the updating unit 1107 can update the chemical feed model such that a lower feed amount is output compared to a case where a single material chemical is fed in.

When there is anti-synergy of combinations of chemicals, there is a possibility that the feed amount of the chemical determined based on the chemical feed model may be excessively small. In this case, since the water quality after a certain time is in a poorer state than the target water quality, the updating unit 1107 revises up the feed amount determined by the determination unit 1105 and updates the chemical feed model. Accordingly, when there is anti-synergy of combinations of chemicals, the updating unit 1107 can update the chemical feed model such that more feed amount is output compared to a case where a single material chemical is fed in.

When the chemical has a preferable side-effect regarding the disruptive factors, the water quality after a certain time is in a more favorable state than the target water quality. Therefore, the updating unit 1107 revises down the feed amount of another chemical of the feed amounts determined by the determination unit 1105 and updates the chemical feed model. On the other hand, when the chemical has an unfavorable side-effect regarding the disruptive factors, the water quality after a certain time is in a poorer state than the target water quality. Therefore, the updating unit 1107 revises up the feed amount of another chemical of the feed amounts determined by the determination unit 1105 and updates the chemical feed model. Accordingly, when the chemical has a side-effect, the updating unit 1107 can update the chemical feed model such that an appropriate feed amount is output.

### Fourth Embodiment

The costs of chemicals are not always the same, and there is a possibility that the cost may vary in accordance with the state of affairs or the like such as the price of crude oil. When the cost of a chemical varies, the chemical feed control device 110 according to a fourth embodiment determines the feed amount of the chemical in consideration of this such that costs are reduced.

<<Constitution of Chemical Feed Control Device>>

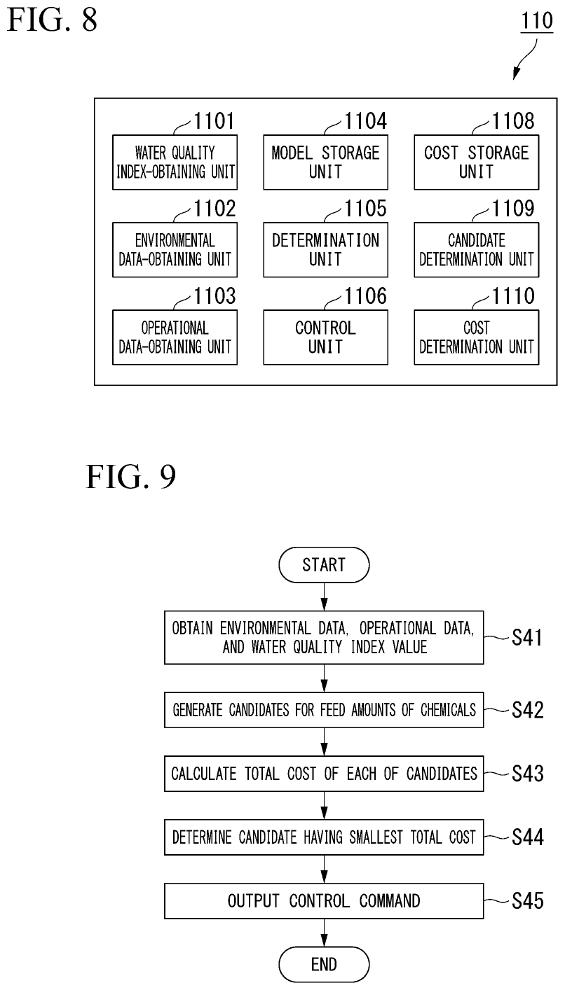

FIG. 8 is a schematic block diagram illustrating a constitution of the chemical feed control device according to an embodiment.

The chemical feed control device 110 according to the fourth embodiment further includes a cost storage unit 1108, a candidate determination unit 1109, and a cost determination unit 1110, in addition to the constituents of the first embodiment as illustrated in FIG. 8.

The cost storage unit 1108 stores the cost per unit amount of each of the chemicals retained in the second chemical tanks 1081. The costs stored in the cost storage unit 1108 can be rewritten by a manager or the like.

The candidate determination unit 1109 determines candidates for the feed amounts of a plurality of chemicals based on the chemical feed model.

The cost determination unit 1110 calculates the total cost of the chemicals regarding each of the candidates based on information stored in the cost storage unit 1108.

The determination unit 1105 of the fourth embodiment determines a candidate which is determined by the cost determination unit 1110 to have the smallest total cost of the plurality of candidates determined by the candidate determination unit 1109.

<<Operation of Chemical Feed Control Device>>

FIG. 9 is a flowchart showing an operation of the chemical feed control device according to an embodiment.

Each of the water quality index-obtaining unit 1101, the environmental data-obtaining unit 1102, and the operational data-obtaining unit 1103 obtains the water quality index value, the environmental data, and the operational data (Step S41). Next, the candidate determination unit 1109 generates a plurality of candidates related to the feed amount of each chemical by substituting the water quality index value, the environmental data, and the operational data into the chemical feed model stored in the model storage unit 1104 (Step S42).

The cost determination unit 1110 calculates the total cost regarding each of the candidates determined by the candidate determination unit 1109 based on the information stored in the cost storage unit 1108 (Step S43). That is, the cost determination unit 1110 calculates a weighted sum of the feed amount of each chemical based on the cost per unit amount regarding each of the candidates. The determination unit 1105 determines a candidate having the smallest total cost of the plurality of candidates (Step S44). The control unit 1106 outputs a control command to each of the second chemical feed pumps 1082 based on the feed amount related to the candidate determined by the determination unit 1105 in Step S44 (Step S45).

<<Operations and Effects>>

In this manner, the chemical feed control device 110 according to the fourth embodiment determines the feed amount of each of a plurality of chemicals based on the costs stored in the cost storage unit such that costs are reduced. Accordingly, the chemical feed control device 110 can determine the feed amount of the chemical such that costs are reduced regardless of change in cost of the chemical.

### Fifth Embodiment

The chemical feed control devices 110 according to the first to fourth embodiments determine the feed amount of the chemical to achieve a specific target water quality. On the other hand, the chemical feed control device 110 according to a fifth embodiment determines the feed amount of the chemical such that cost-effectiveness of the chemical increases.

<<Constitution of Chemical Feed Control Device>>

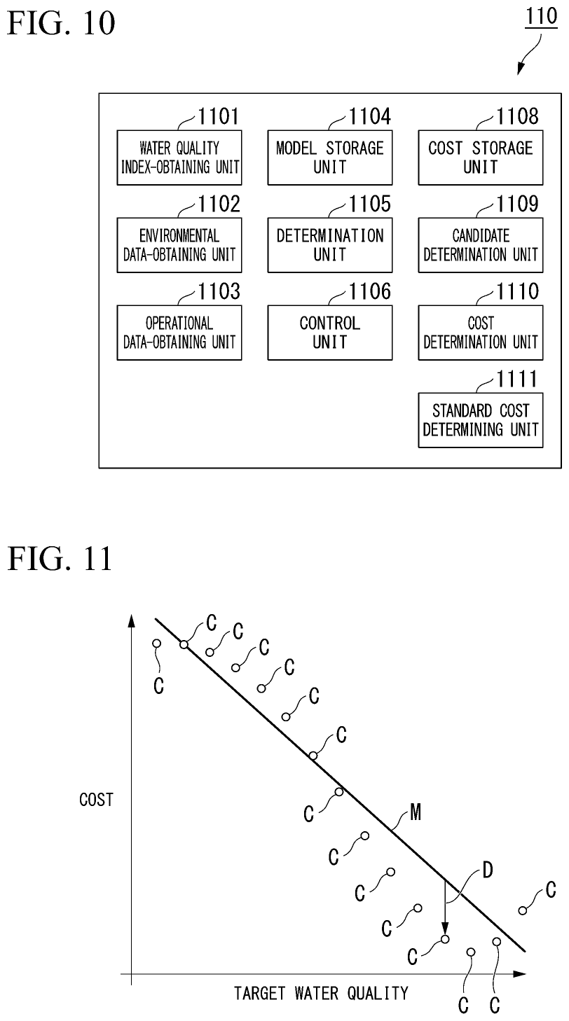

FIG. 10 is a schematic block diagram illustrating a constitution of the chemical feed control device according to an embodiment.

The chemical feed control device 110 according to the fifth embodiment further includes a standard cost determining unit 1111, in addition to the constituents of the fourth embodiment as illustrated in FIG. 10.

The standard cost determining unit 1111 determines a standard cost regarding a plurality of target water qualities based on a preset cost model indicating a relationship between an improvement factor of the water quality and the standard cost of the chemical.

The candidate determination unit 1109 according to the fifth embodiment determines the candidates for the feed amounts of a plurality of chemicals for each of the target water qualities based on the chemical feed model.

The determination unit 1105 according to the fifth embodiment determines a candidate, of the plurality of candidates determined by the candidate determination unit 1109, having a largest cost difference when the total cost determined by the cost determination unit 1110 is subtracted from the standard cost determined by the standard cost determining unit 1111.

FIG. 11 is a view illustrating an example of a relationship between a standard cost and a total cost.

As illustrated in FIG. 11, a cost model M is a model showing a relationship between the target water quality and the standard cost. Here, the candidate determination unit 1109 generates a candidate C for each of the target water qualities, and the cost determination unit 1110 calculates the total cost for each of the candidates, so that the total cost of the target water qualities can be acquired. The determination unit 1105 calculates a cost difference D for each of the target water qualities by subtracting the total cost from the standard cost for each of the target water qualities. The determination unit 1105 determines the candidate C having the largest cost difference D as the feed amount of the chemical.

<<Operation of Chemical Feed Control Device>>

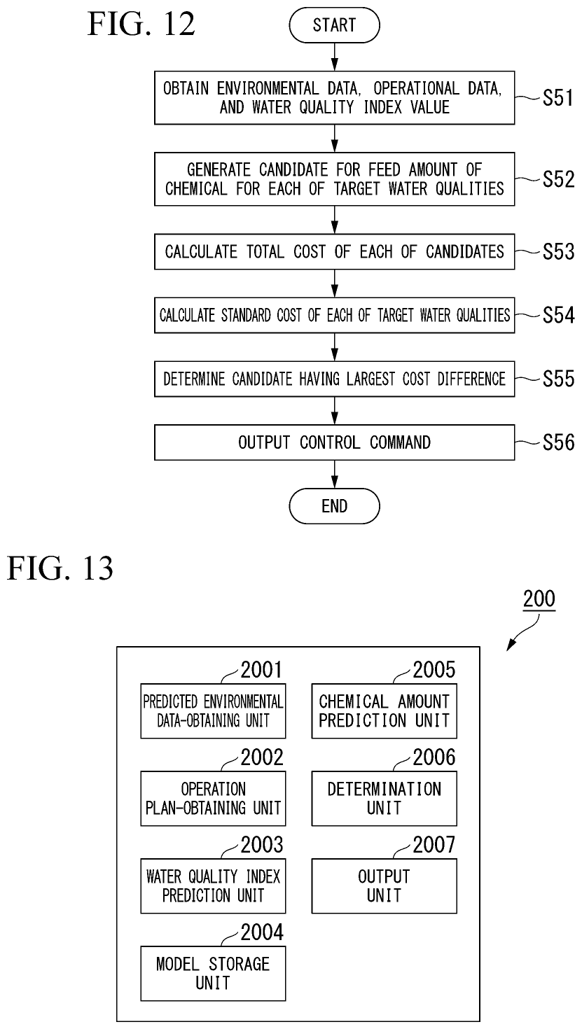

FIG. 12 is a flowchart showing an operation of the chemical feed control device according to an embodiment.

Each of the water quality index-obtaining unit 1101, the environmental data-obtaining unit 1102, and the operational data-obtaining unit 1103 obtains the water quality index value, the environmental data, and the operational data (Step S51). Next, the candidate determination unit 1109 substitutes the water quality index value, the environmental data, and the operational data into the chemical feed model stored in the model storage unit 1104 and generates a candidate related to the feed amount of each chemical for each of the target water qualities (Step S52).

The cost determination unit 1110 calculates the total cost regarding each of the candidates determined by the candidate determination unit 1109 based on the information stored in the cost storage unit 1108 (Step S53). The standard cost determining unit 1111 determines the standard cost for each of the target water qualities related to each of the candidates based on the cost model (Step S54). For example, the standard cost determining unit 1111 obtains the improvement factor of the water quality based on the difference between the water quality index value obtained in Step S51 and each of the target water qualities, and determines the standard cost related to each of the improvement factors as the standard cost for each of the target water qualities.

The determination unit 1105 determines a candidate having the largest cost difference between the standard cost and the total cost of the plurality of candidates (Step S55). The control unit 1106 outputs a control command to each of the second chemical feed pumps 1082 based on the feed amount related to the candidate determined by the determination unit 1105 in Step S55 (Step S56).

<<Operations and Effects>>

In this manner, the chemical feed control device 110 according to the fifth embodiment determines the standard cost regarding the plurality of target water qualities based on the cost model and determines a candidate having the largest cost difference as the feed amount of the chemical. Accordingly, the chemical feed control device 110 can determine the feed amount of the chemical such that the cost-effectiveness of the chemical increases.

### Sixth Embodiment

The chemical feed control device 110 according to the fifth embodiment determines the feed amount of the chemical such that the cost-effectiveness of the chemical increases. In contrast, a chemical management device according to a sixth embodiment determines a purchasing timing and a purchasing volume of a chemical such that the cost-effectiveness of the chemical increases.

<<Constitution of Chemical Management Device>>

FIG. 13 is a schematic block diagram illustrating a constitution of a chemical management device according to an embodiment.

The power plant 10 according to the sixth embodiment includes a chemical management device 200 illustrated in FIG. 13, in addition to the constituents according to the fifth embodiment. As illustrated in FIG. 13, the chemical management device 200 includes a predicted environmental data-obtaining unit 2001, an operation plan-obtaining unit 2002, a water quality index prediction unit 2003, a model storage unit 2004, a chemical amount prediction unit 2005, a determination unit 2006, and an output unit 2007.

The predicted environmental data-obtaining unit 2001 obtains a prediction value of the environmental data around the power plant 10 during a specific period (for example, two months) starting from the present time as the plant data. For example, the predicted environmental data-obtaining unit 2001 obtains an average value of the environmental data on the same date in the past, a value of a weather forecast, or the like as a prediction value of the environmental data.

The operation plan-obtaining unit 2002 obtains an operation plan of the power plant 10 during the specific period starting from the present time as the plant data. For example, the operation plan may include information such as an operation start time, an operation period, an operation stop time, a timing or a period of regular inspection, and an operational efficiency during the operation period of the power plant 10. The operation plan may express an output of the power plant 10, various kinds of flow rates (steam, water, cooling water, chemicals, or the like), the temperature and the pressure of the boiler, the cooling water temperature, the air volume of the cooling tower, and the like in time series.

The water quality index prediction unit 2003 predicts the water quality index values of the circulating water, the makeup water, and the drainage water during the specific period starting from the present time. For example, the water quality index prediction unit 2003 predicts the water quality index values of the circulating water, the makeup water, and the drainage water by simulating operation of the power plant 10 based on the prediction value of the environmental data obtained by the predicted environmental data-obtaining unit 2001 and the operation plan obtained by the operation plan-obtaining unit 2002.

The model storage unit 2004 stores the chemical feed model and a purchasing model. The chemical feed model is similar to those of the chemical feed models according to the first to fifth embodiments. That is, the chemical feed model is a model for obtaining the feed amount of each chemical from a combination of the water quality index value and the plant data.

The purchasing model is a model for outputting the purchasing volume of each of the chemicals by inputting a used amount of the chemical during the specific period, a change in storage amount, and information related to the cost of each of the chemicals. Examples of the information related to the cost of each of the chemicals include a price per unit amount, efficiency per unit amount, a size of a tank, an allowable storage amount enacted by the laws, and an expiration date. The price per unit amount may use a value at the time of calculation or may be determined based on predicted price variation.

For example, the purchasing model is a machine learning model such as a neural network. The purchasing model is learned from a combination of a used amount of the chemical during the specific period, a change in storage amount, and the information related to the cost of each of the chemicals through reinforcement learning to output the purchasing timing and the purchasing volume of each of the chemicals such that the purchasing cost of the chemical becomes the minimum, the chemical does not become insufficient within a specific period, and each of the chemicals does not exceed the allowable storage amount within the specific period. That is, the purchasing model is learned such that remuneration increases as the purchasing cost of the chemical during the specific period is reduced and a penalty is applied when the chemical becomes insufficient during the specific period and when the chemical exceeds the allowable storage amount. The purchasing model is learned by repetitively calculating the chemical amount during the specific period using the chemical feed model to determine the used amount of the chemical during the specific period and the storage amount of the chemical, and calculating the remuneration based on the calculation result thereof.

The chemical amount prediction unit 2005 predicts the used amount of the chemical during the specific period and a change in storage amount by inputting the prediction value of the environmental data obtained by the predicted environmental data-obtaining unit 2001, the operation plan obtained by the operation plan-obtaining unit 2002, and the water quality index value predicted by the water quality index prediction unit 2003 to the chemical feed model. At this time, the chemical amount prediction unit 2005 predicts the used amount of the chemical such that the cost difference becomes the maximum based on the standard cost, similar to the fifth embodiment.

The determination unit 2006 determines the purchasing timing and the purchasing volume of each of the chemicals by inputting the used amount of the chemical during the specific period, a change in storage amount, and the information related to the cost of each of the chemicals predicted by the chemical amount prediction unit 2005 to the purchasing model.

The output unit 2007 causes an output device such as a display (not illustrated) to output the purchasing timing and the purchasing volume of each of the chemicals determined by the determination unit 2006. In other embodiments, the output unit 2007 may output a purchase request of a chemical to a seller of the chemical based on the purchasing timing and the purchasing volume of each of the chemicals.

<<Operation of Chemical Feed Control Device>>

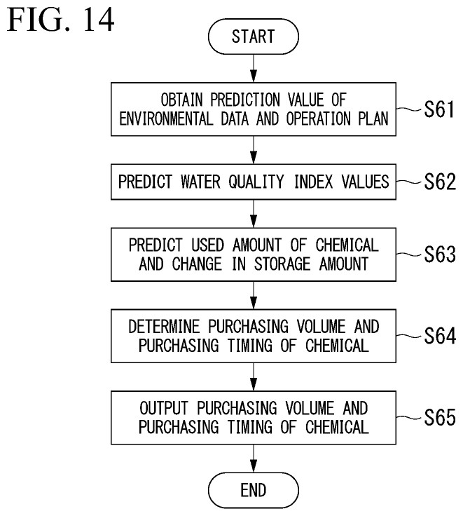

FIG. 14 is a flowchart showing an operation of the chemical management device according to an embodiment.

Each of the predicted environmental data-obtaining unit 2001 and the operation plan-obtaining unit 2002 obtains the prediction value of the environmental data around the power plant 10 during the specific period starting from the present time and the operation plan of the power plant 10 (Step S61). The water quality index prediction unit 2003 predicts the water quality index values of the circulating water, the makeup water, and the drainage water by simulating operation of the power plant 10 based on the prediction value of the environmental data obtained in Step S61 and the operation plan (Step S62).

The chemical amount prediction unit 2005 predicts the used amount of the chemical during the specific period and a change in storage amount by inputting the prediction value of the environmental data obtained in Step S61, the operation plan, and the water quality index value predicted in Step S62 to the chemical feed model (Step S63). The determination unit 2006 determines the purchasing timing and the purchasing volume of each of the chemicals by inputting the used amount of the chemical during the specific period, a change in storage amount, and the information related to the cost of each of the chemicals predicted in Step S63 to the purchasing model (Step S64). The output unit 2007 outputs the purchasing timing and the purchasing volume of each of the chemicals determined by the determination unit 2006 (Step S65).

<<Operations and Effects>>

In this manner, the chemical management device 200 according to the sixth embodiment predicts the feed amount of the chemical during the specific period and determines the purchasing volume and the purchasing timing of the chemical such that costs are lowered based on a change in predicted feed amount of the chemical. Accordingly, the chemical management device 200 can determine the purchasing volume and the purchasing timing of the chemical such that the cost-effectiveness of the chemical increases. In other embodiments, the chemical management device 200 may determine the purchasing volume of each of the chemicals and does not have to take the purchasing timing into consideration. In addition, in other embodiments, when the storage amount of the chemical is not restricted, the chemical management device 200 may determine the purchasing volume of each of the chemicals without taking the allowable storage amount into consideration. In addition, the chemical management device 200 according to other embodiments may determine the purchasing volume of each of the chemicals by further taking increase and decrease of tanks or a storeroom for storing the chemical into consideration.

<Other Embodiments>

Hereinabove, embodiments have been described in detail with reference to the drawings. However, a specific constitution is not limited to those described above, and various design changes and the like can be made.

In the chemical feed control devices 110 according to the embodiments described above, a chemical is fed into the circulating water system of the power plant, but it is not limited thereto. The chemical feed control device 110 according to other embodiments may be applied to various plant facilities other than a power plant, for example, various industrial plants such as a petroleum plant, a chemical plant, and a steel plant.

The chemical feed control device 110 according to the embodiments described above controls feeding of the chemical in the cooling water circulating line 105, but it is not limited thereto.

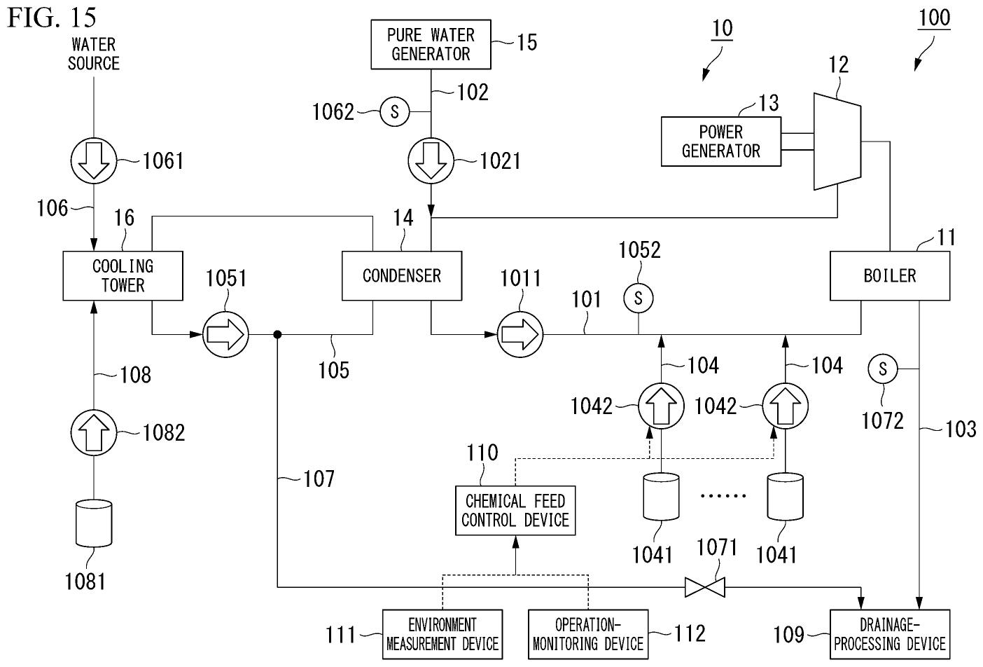

FIG. 15 is a schematic block diagram illustrating a constitution of the water treatment system according to an embodiment.

For example, as illustrated in FIG. 15, when the water treatment system 100 according to other embodiments includes a plurality of first chemical tanks 1041 and a plurality of first chemical feed pumps 1042, the chemical feed control device 110 may control feeding of the chemical into the steam circulating line 101 (circulating water system). In addition, the chemical feed control device 110 according to other embodiments may control feeding of the chemical in a water system such as a water-cooling heat exchanger (air conditioner or the like).

The chemical feed control device 110 according to the embodiments described above controls the feed amount of the chemical based on the chemical feed model learned through machine learning, but it is not limited thereto. For example, the chemical feed model according to other embodiments may be generated without depending on machine learning.

The chemical feed model according to the embodiments described above inputs the water quality index value, the environmental data, and the operational data and outputs the feed amount of each chemical, but it is not limited thereto. For example, the chemical feed model according to other embodiments may output the feed amount of each chemical from the water quality index value. In this case, the chemical feed control device 110 may obtain the feed amount of each chemical without depending on the environmental data and the operational data, or may obtain the water quality index value after a certain time from the water quality index value, the environmental data, and the operational data to obtain the feed amount of each chemical by substituting the water quality index value after a certain time into the chemical feed model.

### Seventh Embodiment

Various state quantities in a plant change by operating an auxiliary machine. Accordingly, power of certain equipment changes, and there is a possibility that a state quantity used for determining power of other auxiliary machines may change. For example, when power of a circulating water pump changes, the flow velocity of the circulating water changes, and the heat exchange amount per unit time changes.

Accordingly, when each of the auxiliary machines is rationalized based on the individual state quantity, there is a possibility that it may not lead to optimal control over a plurality of auxiliary machines in their entirety.

Therefore, the water treatment system according to a seventh embodiment rationalizes power of the auxiliary machine in consideration of the state of a plurality of auxiliary machines.

<<Constitution of Water Treatment System>>

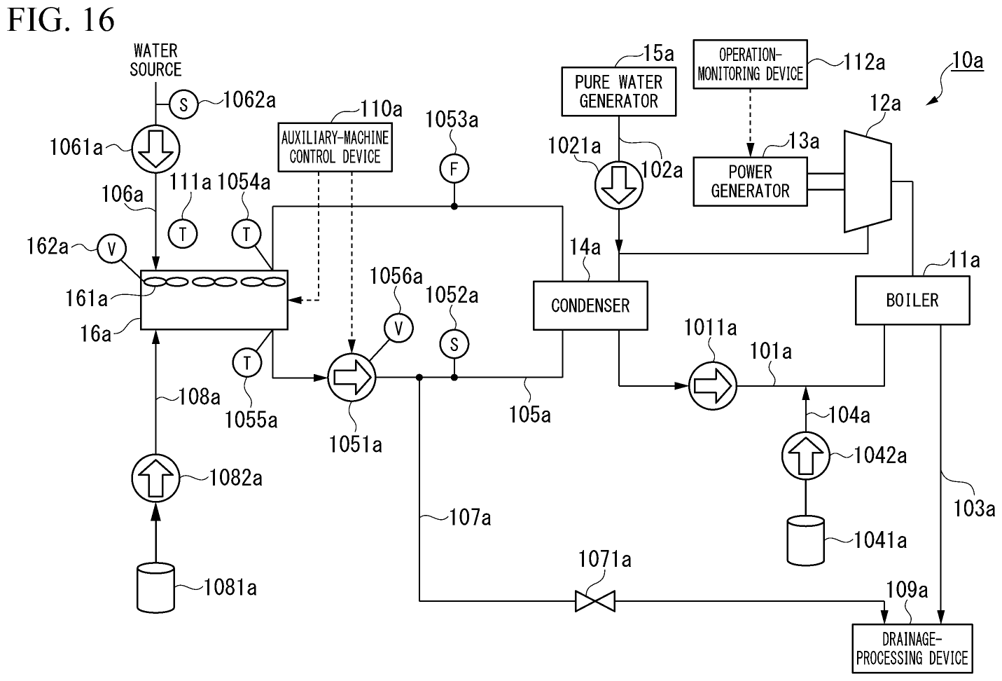

FIG. 16 is a schematic block diagram illustrating a constitution of a power plant according to an embodiment.

A power plant 10a includes a boiler 11a, a steam turbine 12a, a power generator 13a, a condenser 14a, a pure water generator 15a, a cooling tower 16a, a steam circulating line 101a, a first supply line 102a, a first drainage line 103a, a first chemical feed line 104a, a cooling water circulating line 105a, a second supply line 106a, a second drainage line 107a, a second chemical feed line 108a, a drainage-processing device 109a, an auxiliary-machine control device 110a, an environment measurement device 111a, and an operation-monitoring device 112a.

The boiler 11a generates steam by evaporating water.

The steam turbine 12a rotates due to steam generated by the boiler 11a.

The power generator 13a converts rotation energy of the steam turbine 12a into electric power.

The condenser 14a performs heat exchange between steam discharged from the steam turbine 12a and the cooling water, such that steam returns to water.

The pure water generator 15a generates pure water.

The cooling tower 16a cools the cooling water subjected to heat exchange in the condenser 14a. A fan 161a for urging the cooling water to be evaporated, and a first wattmeter 162a for measuring consumed electric power of the fan 161a are provided in the cooling tower 16a. The fan 161a is constituted such that the air volume can be adjusted by controlling the number of fans and controlling the inverter. The first wattmeter 162a transmits fan power which is consumed electric power measured by the auxiliary-machine control device 110a.

The steam circulating line 101a is a line for causing water and steam to circulate in the steam turbine 12a, the condenser 14a, and the boiler 11a. A first water feeding pump 1011a is provided between the condenser 14a and the boiler 11a in the steam circulating line 101a. The first water feeding pump 1011a pressure-feeds water from the condenser 14a toward the boiler 11a.

The first supply line 102a is a line for supplying pure water generated by the pure water generator 15a to the steam circulating line 101a. A second water feeding pump 1021a is provided in the first supply line 102a. The second water feeding pump 1021a is used at the time of filling the condenser 14a with water. During operation, water inside the first supply line 102a is pressure-fed from the pure water generator 15a toward the condenser 14a due to decompression of the condenser 14a.

The first drainage line 103a is a line for discharging a part of water circulating in the steam circulating line 101a from the boiler 11a to the drainage-processing device 109a.

The first chemical feed line 104a is a line for supplying a chemical such as a corrosion preventive agent, a scaling preventive agent, or a slime control agent to the steam circulating line 101a. The first chemical feed line 104a includes a first chemical tank 1041a retaining a chemical, and a first chemical feed pump 1042a supplying the chemical from the first chemical tank 1041a to the steam circulating line 101a.

The cooling water circulating line 105a is a line for causing the cooling water to circulate in the condenser 14a and the cooling tower 16a. A third water feeding pump 1051a, a cooling water quality sensor 1052a, a circulating water amount sensor 1053a, a cooling tower inlet water temperature sensor 1054a, a cooling tower outlet water temperature sensor 1055a, and a second wattmeter 1056a are provided in the cooling water circulating line 105a. The third water feeding pump 1051a pressure-feeds the cooling water from the cooling tower 16a toward the condenser 14a.

The cooling water quality sensor 1052a detects the water quality of the cooling water circulating in the cooling water circulating line 105a. Examples of the water quality detected by the sensor include an electrical conductivity, a pH value, a salt concentration, a metal concentration, a chemical oxygen demand (COD), a biochemical oxygen demand (BOD), a microbial concentration, a silica concentration, and combinations of these. The cooling water quality sensor 1052a outputs the circulating water quality index value indicating the detected water quality to the auxiliary-machine control device 110a. The circulating water amount sensor 1053a detects the flow rate of the cooling water circulating in the cooling water circulating line 105a. The circulating water amount sensor 1053a outputs a circulating water amount indicating the detected water amount to the auxiliary-machine control device 110a. The cooling tower inlet water temperature sensor 1054a detects the temperature of the cooling water circulating in the cooling water circulating line 105a. The cooling tower inlet water temperature sensor 1054a outputs the circulating water temperature indicating the detected temperature to the auxiliary-machine control device 110a. The second wattmeter 1056a measures consumed electric power of the third water feeding pump 1051a. The second wattmeter 1056a outputs pump electric power indicating measured consumed electric power to the auxiliary-machine control device 110a.

The second supply line 106a is a line for supplying raw water taken from the water source to the cooling water circulating line 105a as makeup water. A fourth water feeding pump 1061a and a makeup water quality sensor 1062a are provided in the second supply line 106a. The fourth water feeding pump 1061a pressure-feeds the makeup water from the water source toward the cooling tower 16a. The makeup water quality sensor 1062a outputs the makeup water quality index value indicating the detected water quality to the auxiliary-machine control device 110a.

The second drainage line 107a is a line for discharging a part of water circulating in the cooling water circulating line 105a to the drainage-processing device 109a. A blow valve 1071a and a drainage water quality sensor 1072a are provided in the second drainage line 107a. The blow valve 1071a restricts the amount of the drainage water to be blown from the cooling water circulating line 105a to the drainage-processing device 109a.

The second chemical feed line 108a is a line for supplying a chemical to the cooling water circulating line 105a. The second chemical feed line 108a includes a second chemical tank 1081a retaining a chemical, and a second chemical feed pump 1082a supplying a chemical from the second chemical tank 1081a to the cooling water circulating line 105a.

The drainage-processing device 109a feeds an acid, an alkali, a flocculant, or other chemicals into the drainage water discharged from the first drainage line 103a and the second drainage line 107a. The drainage-processing device 109a discards the drainage water processed using the chemical.

The auxiliary-machine control device 110a determines power of the fan 161a and power of the third water feeding pump 1051a based on fan power detected by the first wattmeter 162a, the cooling water quality index value detected by the cooling water quality sensor 1052a, the makeup water quality index value detected by the makeup water quality sensor 1062a, the circulating water amount detected by the circulating water amount sensor 1053a, a cooling tower inlet water temperature detected by the cooling tower inlet water temperature sensor 1054a, a cooling tower outlet water temperature detected by the cooling tower outlet water temperature sensor 1055a, pump electric power detected by the second wattmeter 1056a, a wet-bulb temperature measured by the environment measurement device 111a, and generated electric power measured by the operation-monitoring device 112a. The fan 161a and the third water feeding pump 1051a are examples of the auxiliary machine.

The environment measurement device 111a measures the wet-bulb temperature in the vicinity of the cooling tower 16a.

The operation-monitoring device 112a measures electric power generated by the power plant 10a.

<<Relationship Between State Quantity of Power Plant and Auxiliary Machine>>

The fan 161a promotes evaporation of water in the cooling tower 16a. Therefore, there is a need to increase the power of the fan 161a as water is less likely to be evaporated in the cooling tower 16a. An evaporation amount of water varies depending on the wet-bulb temperature of the atmosphere. That is, the wet-bulb temperature in the vicinity of the cooling tower 16a is an example of the state quantity affecting the fan 161a.

The third water feeding pump 1051a controls the circulating amount of the cooling water in the cooling water circulating line 105a. In order to prevent occurrence of disruption such as corrosion, scaling, or fouling in the cooling water circulating line 105a, and in order to reduce an environmental load due to blow water, there is a need to maintain the water quality of the cooling water to be equal to or higher than a certain water quality. That is, the cooling water quality index value and the makeup water quality index value are examples of the state quantity affecting the third water feeding pump 1051a. In addition, there is a need to increase the heat exchange amount in the condenser 14a as the power plant 10a generates more electric power. Therefore, there is a need to increase the operation amount of the third water feeding pump 1051a. That is, electric power generated by the power plant 10a is an example of the state quantity affecting the third water feeding pump 1051a.

When the water quality of the cooling water is favorable, even if circulating multiples are increased, there is a possibility that the water quality may be able to be maintained to be equal to or higher than a certain water quality. In this case, when increase in circulating multiples is allowed, power of the third water feeding pump 1051a can be decreased. Meanwhile, if power of the third water feeding pump 1051a is decreased, the flow velocity of the cooling water subjected to heat exchange in the cooling tower 16a decreases. Therefore, there is a possibility that the heat exchange amount may decrease. Accordingly, since the emission amount of heat taken by the cooling tower 16a decreases, there is a need to increase the power of the fan 161a.

<<Constitution of Auxiliary-Machine Control Device>>

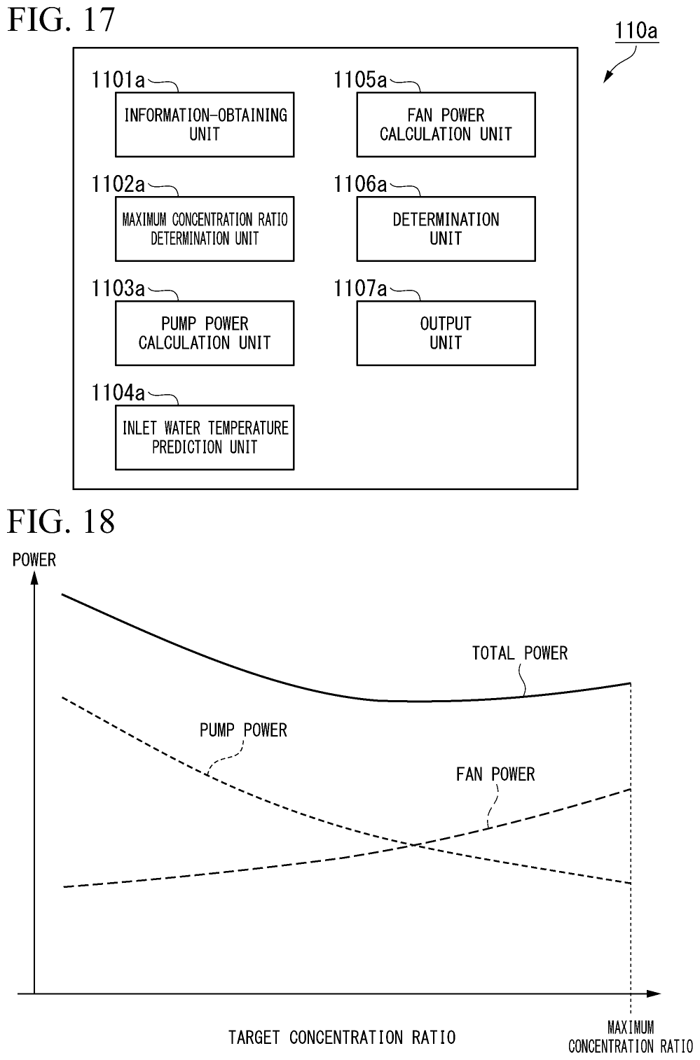

FIG. 17 is a schematic block diagram illustrating a constitution of an auxiliary-machine control device according to an embodiment.

The auxiliary-machine control device 110a includes an information-obtaining unit 1101a, a maximum concentration ratio determination unit 1102a, a pump power calculation unit 1103a, an inlet water temperature prediction unit 1104a, a fan power calculation unit 1105a, a determination unit 1106a, and an output unit 1107a.

The information-obtaining unit 1101a obtains fan power detected by the first wattmeter 162a, the cooling water quality index value detected by the cooling water quality sensor 1052a, the makeup water quality index value detected by the makeup water quality sensor 1062a, the circulating water amount detected by the circulating water amount sensor 1053a, the cooling tower inlet water temperature detected by the cooling tower inlet water temperature sensor 1054a, the cooling tower outlet water temperature detected by the cooling tower outlet water temperature sensor 1055a, pump electric power detected by the second wattmeter 1056a, the wet-bulb temperature measured by the environment measurement device 111a, and generated electric power measured by the operation-monitoring device 112a.

The maximum concentration ratio determination unit 1102a determines a maximum concentration ratio allowed in the cooling water circulating line 105a based on the cooling water quality index value, the makeup water quality index value, and generated electric power obtained by the information-obtaining unit 1101a. Regarding the maximum concentration ratio determination unit 1102a, for example, the maximum concentration ratio determination unit 1102a may determine the maximum concentration ratio based on a table in which the cooling water quality index value, the makeup water quality index value, generated electric power, and the maximum concentration ratio are associated with each other, or may determine the maximum concentration ratio based on the cooling water quality after a certain time by predicting the cooling water quality after a certain time from the cooling water quality index value, the makeup water quality index value, and generated electric power. The maximum concentration ratio has a higher value as the cooling water quality index value becomes lower (as the water quality increases).

The pump power calculation unit 1103a calculates the power of the third water feeding pump 1051a when a plurality of concentration ratios equal to or lower than the maximum concentration ratio determined by the maximum concentration ratio determination unit 1102a are set as target concentration ratios. If the target concentration ratios are set, the pump power calculation unit 1103a can calculate the blow water amount and the circulating water amount corresponding thereto. The blow water amount and the circulating water amount have lower values as the target concentration ratio increases.

The inlet water temperature prediction unit 1104a predicts the cooling tower inlet water temperature after a certain time based on the cooling tower outlet water temperature and generated electric power obtained by the information-obtaining unit 1101a. The heat exchange amount in the condenser 14a increases as more electric power is generated. Accordingly, the cooling tower inlet water temperature rises as more electric power is generated. In addition, the cooling tower inlet water temperature rises as the cooling tower outlet water temperature rises.

The fan power calculation unit 1105a calculates the power of the fan 161a for each of the target concentration ratios based on the cooling tower inlet water temperature after a certain time predicted by the inlet water temperature prediction unit 1104a, the wet-bulb temperature of the atmosphere obtained by the information-obtaining unit 1101a, and the circulating water amount calculated by the pump power calculation unit 1103a. The power of the fan 161a is increased as the wet-bulb temperature rises, is increased as the cooling tower inlet water temperature rises, and is lowered as the circulating water amount increases.

FIG. 18 is a view illustrating an example of a relationship between power of a third water feeding pump and power of a fan.

The determination unit 1106a determines a target concentration ratio, of a plurality of target concentration ratios, in which the sum of power of the third water feeding pump 1051a and power of the fan 161a becomes the minimum, based on the power of the third water feeding pump 1051a for each of the target concentration ratios calculated by the pump power calculation unit 1103a and power of the fan 161a for each of the target concentration ratios calculated by the fan power calculation unit 1105a. The determination unit 1106a determines power of the third water feeding pump 1051a and power of the fan 161a related to the determined target concentration ratio as the power of the third water feeding pump 1051a and the power of the fan 161a.

As illustrated in FIG. 18, power of the third water feeding pump 1051a and power of the fan 161a have a trade-off relationship therebetween. In the example of FIG. 18, the determination unit 1106a determines a target concentration ratio in which the sum of power of the third water feeding pump 1051a and power of the fan 161a becomes the minimum at the target concentration ratio related to an intersection between a line indicating power of the third water feeding pump 1051a and a line indicating power of the fan 161a. As illustrated in FIG. 18, since each of the target concentration ratios is a value equal to or lower than the maximum concentration ratio calculated by the maximum concentration ratio determination unit 1102a, the determination unit 1106a can maintain the water quality of the cooling water at a certain level or higher using power related to any of the plurality of target concentration ratios.

The output unit 1107a outputs an instruction to the third water feeding pump 1051a and the fan 161a to be operated with power determined by the determination unit 1106a.

<<Operation of Auxiliary-Machine Control Device>>

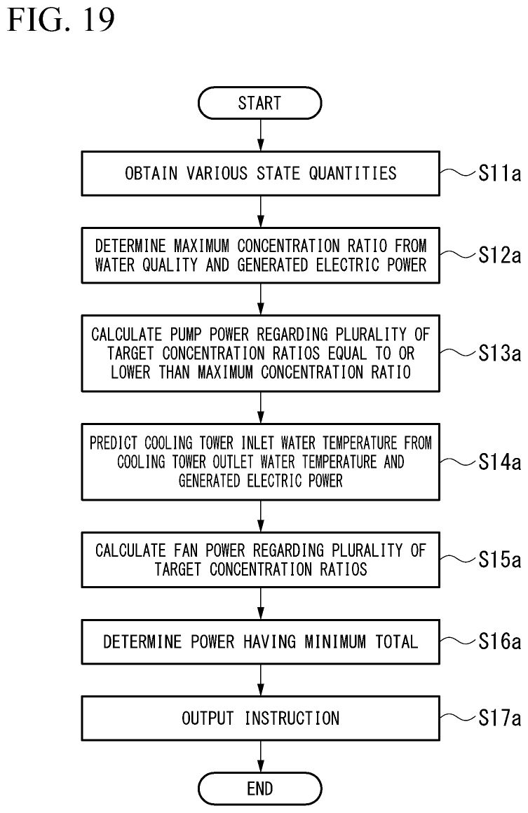

FIG. 19 is a flowchart showing an operation of the auxiliary-machine control device according to an embodiment.

The information-obtaining unit 1101a obtains fan power detected by the first wattmeter 162a, the cooling water quality index value detected by the cooling water quality sensor 1052a, the makeup water quality index value detected by the makeup water quality sensor 1062a, the circulating water amount detected by the circulating water amount sensor 1053a, the cooling tower inlet water temperature detected by the cooling tower inlet water temperature sensor 1054a, the cooling tower outlet water temperature detected by the cooling tower outlet water temperature sensor 1055a, pump electric power detected by the second wattmeter 1056a, the wet-bulb temperature measured by the environment measurement device 111a, and generated electric power measured by the operation-monitoring device 112a (Step S11a).

Next, the maximum concentration ratio determination unit 1102a determines the maximum concentration ratio allowed in the cooling water circulating line 105a based on the cooling water quality index value, the makeup water quality index value, and generated electric power obtained by the information-obtaining unit 1101a (Step S12a). The pump power calculation unit 1103a calculates the power of the third water feeding pump 1051a when the plurality of concentration ratios equal to or lower than the maximum concentration ratio determined by the maximum concentration ratio determination unit 1102a are set as the target concentration ratios (Step S13a).

The inlet water temperature prediction unit 1104a predicts the cooling tower inlet water temperature after a certain time based on the cooling tower outlet water temperature and generated electric power obtained by the information-obtaining unit 1101a (Step S14a). The fan power calculation unit 1105a calculates the power of the fan 161a for each of the target concentration ratios based on the cooling tower inlet water temperature after a certain time predicted by the inlet water temperature prediction unit 1104a, the wet-bulb temperature of the atmosphere obtained by the information-obtaining unit 1101a, and the circulating water amount calculated by the pump power calculation unit 1103a (Step S15a). Calculating the power of the fan 161a based on the power of the third water feeding pump 1051a which has been determined based on the cooling water quality index value, the makeup water quality index value, and generated electric power is equivalent to determining the power of the fan 161a based on the cooling water quality index value, the makeup water quality index value, and generated electric power.

The determination unit 1106a determines a target concentration ratio, of the plurality of target concentration ratios of equal to or lower than the maximum concentration ratio, in which the sum of power of the third water feeding pump 1051a and power of the fan 161a becomes the minimum, and determines power of the third water feeding pump 1051a and power of the fan 161a related to the target concentration ratio thereof as the power of the third water feeding pump 1051a and the power of the fan 161a (Step S16a). The output unit 1107a outputs an instruction to the third water feeding pump 1051a and the fan 161a to be operated with power determined by the determination unit 1106a (Step S17a). Accordingly, the third water feeding pump 1051a and the fan 161a can be operated with less power while the water quality inside the cooling water circulating line 105a is maintained at a certain level or higher.

<<Operations and Effects>>

In this manner, according to the seventh embodiment, the auxiliary-machine control device 110a determines power of the fan 161a serving as one of the plurality of auxiliary machines based on the cooling water quality index value, the makeup water quality index value, and generated electric power which are the state quantities of the power plant 10a affecting the third water feeding pump 1051a serving as one of the plurality of auxiliary machines. Accordingly, the auxiliary-machine control device 110a can determine power of the fan 161a in accordance with the water quality in the cooling water circulating line 105a.

In addition, according to the seventh embodiment, the auxiliary-machine control device 110a determines power such that the sum of power of the third water feeding pump 1051a and power of the fan 161a becomes the minimum. Accordingly, electric power consumed by the auxiliary machines in the plant can be reduced, and actually generated electric power can be increased.

The power of the third water feeding pump 1051a which is a pump for pressure-feeding water of the circulating water system in the power plant 10a and the power of the fan 161a of the cooling tower 16a occupy most of the total power of the auxiliary machines in the entire power plant 10a. Therefore, consumed electric power of the entire power plant 10a can be reduced significantly by minimizing the total value of power of the third water feeding pump 1051a and power of the fan 161a of the cooling tower 16a.

### Eighth Embodiment

The auxiliary-machine control device 110a according to the seventh embodiment determines power of the third water feeding pump 1051a and power of the fan 161a such that the total power becomes the minimum. Meanwhile, depending on a price of water acquired from the water source and a power-selling price, there is a possibility that it may be inexpensive when the blow water amount and power of the third water feeding pump 1051a are further increased or further reduced.

In consideration of this, the auxiliary-machine control device 110a according to an eighth embodiment determines power of the auxiliary machine such that actually generated electric power of the plant becomes the maximum.

<<Constitution of Auxiliary-Machine Control Device>>

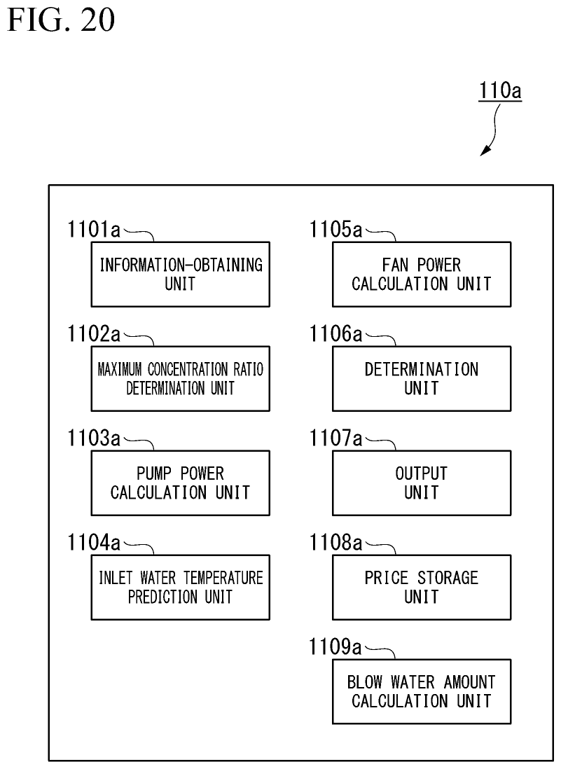

FIG. 20 is a schematic block diagram illustrating a constitution of the auxiliary-machine control device according to an embodiment.

The auxiliary-machine control device 110a according to the eighth embodiment further includes a price storage unit 1108a and a blow water amount calculation unit 1109a, in addition to the constituents according to the seventh embodiment.

The price storage unit 1108a stores the price per unit amount of water obtained from the water source, and the power-selling price per unit electric power.

The blow water amount calculation unit 1109a calculates the water amount (blow water amount) to be drained from the second drainage line 107a when the plurality of concentration ratios equal to or lower than the maximum concentration ratio determined by the maximum concentration ratio determination unit 1102a are set as the target concentration ratios. The blow water amount has a lower value as the target concentration ratio increases.

The determination unit 1106a according to the eighth embodiment calculates the power-selling price of electric power consumed by operation of the third water feeding pump 1051a and the fan 161a based on power of the third water feeding pump 1051a and power of the fan 161a for each of the target concentration ratios, and the power-selling price per unit electric power stored in the price storage unit 1108a. In addition, the determination unit 1106a calculates the price of water obtained from the water source based on the blow water amount for each of the target concentration ratios and the price per unit amount of water stored in the price storage unit 1108a. The determination unit 1106a determines a target concentration ratio, of the plurality of target concentration ratios, in which the sum of the power-selling price of consumed electric power and the price of water obtained from the water source becomes the minimum. The determination unit 1106a determines power of the third water feeding pump 1051a and power of the fan 161a related to the determined target concentration ratio as the power of the third water feeding pump 1051a and power of the fan 161a.

<<Operation of Auxiliary-Machine Control Device>>

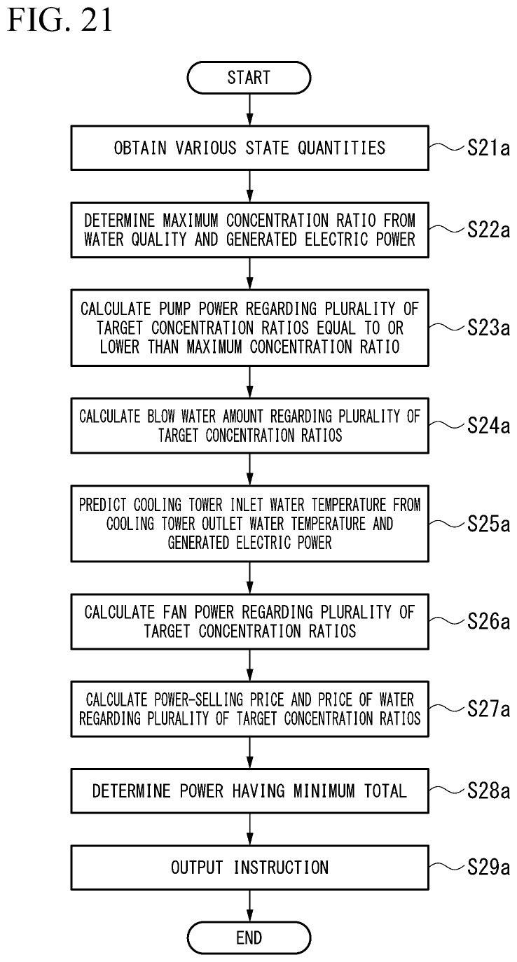

FIG. 21 is a flowchart showing an operation of the auxiliary-machine control device according to an embodiment.

The information-obtaining unit 1101a obtains fan power detected by the first wattmeter 162a, the cooling water quality index value detected by the cooling water quality sensor 1052a, the makeup water quality index value detected by the makeup water quality sensor 1062a, the circulating water amount detected by the circulating water amount sensor 1053a, the cooling tower inlet water temperature detected by the cooling tower inlet water temperature sensor 1054a, the cooling tower outlet water temperature detected by the cooling tower outlet water temperature sensor 1055a, pump electric power detected by the second wattmeter 1056a, the wet-bulb temperature measured by the environment measurement device 111a, and generated electric power measured by the operation-monitoring device 112a (Step S21a).

Next, the maximum concentration ratio determination unit 1102a determines the maximum concentration ratio allowed in the cooling water circulating line 105a based on the cooling water quality index value, the makeup water quality index value, and generated electric power obtained by the information-obtaining unit 1101a (Step S22a). The pump power calculation unit 1103a calculates the power of the third water feeding pump 1051a when the plurality of concentration ratios equal to or lower than the maximum concentration ratio determined by the maximum concentration ratio determination unit 1102a are set as the target concentration ratios (Step S23a). In addition, the blow water amount calculation unit 1109a calculates the blow water amount from the second drainage line 107a when the plurality of concentration ratios equal to or lower than the maximum concentration ratio determined by the maximum concentration ratio determination unit 1102a are set as the target concentration ratios (Step S24a).

The inlet water temperature prediction unit 1104a predicts the cooling tower inlet water temperature after a certain time based on the cooling tower outlet water temperature and generated electric power obtained by the information-obtaining unit 1101a (Step S25a). The fan power calculation unit 1105a calculates the power of the fan 161a for each of the target concentration ratios based on the cooling tower inlet water temperature after a certain time predicted by the inlet water temperature prediction unit 1104a, the wet-bulb temperature of the atmosphere obtained by the information-obtaining unit 1101a, and the circulating water amount calculated by the pump power calculation unit 1103a (Step S26a).

The determination unit 1106a calculates the power-selling price of electric power consumed by the third water feeding pump 1051a related to each of the target concentration ratios, the power-selling price of electric power consumed by the fan 161a related to each of the target concentration ratios, and the price of water supplied from the water source related to each of the target concentration ratios based on the information stored in the price storage unit 1108a (Step S27a). The determination unit 1106a determines a target concentration ratio in which the sum of the power-selling price of electric power and the price of water becomes the minimum, and power of the third water feeding pump 1051a and power of the fan 161a related to the target concentration ratio thereof as the power of the third water feeding pump 1051a and power of the fan 161a (Step S28a). The output unit 1107a outputs an instruction to the third water feeding pump 1051a and the fan 161a to be operated with power determined by the determination unit 1106a (Step S29a). Accordingly, the third water feeding pump 1051a and the fan 161a can be operated such that expense is reduced while the water quality inside the cooling water circulating line 105a is maintained at a certain level or higher.

<<Operations and Effects>>

In this manner, according to the eighth embodiment, the auxiliary-machine control device 110a determines power such that the sum of the power-selling price for the power of the third water feeding pump 1051a and the power of the fan 161a, and the price of the makeup water from the water source becomes the minimum. Accordingly, the auxiliary-machine control device 110a can reduce the expense for the auxiliary machine and can increase the actual power-selling price.

### Ninth Embodiment

It is known that characteristics of the power plant 10a change due to deterioration or the like. Therefore, the auxiliary-machine control device 110a according to a ninth embodiment determines power of an appropriate auxiliary machine in accordance with change in the power plant 10a through machine learning or simulation performed based on the state of the power plant 10a.

<<Constitution of Auxiliary-Machine Control Device>>

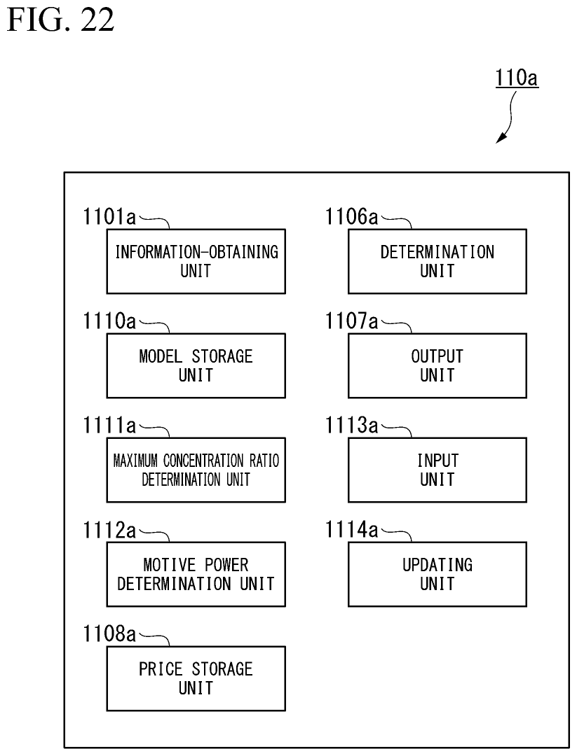

FIG. 22 is a schematic block diagram illustrating a constitution of the auxiliary-machine control device according to an embodiment.

The auxiliary-machine control device 110a includes an information-obtaining unit 1101a, a model storage unit 1110a, a maximum concentration ratio determination unit 1111a, a motive power determination unit 1112a, the price storage unit 1108a, the determination unit 1106a, the output unit 1107a, an input unit 1113a, and an updating unit 1114a.

The model storage unit 1110a stores a concentration ratio model for outputting the maximum concentration ratio while having the information obtained by the information-obtaining unit 1101a as an input, power of the third water feeding pump 1051a and power of the fan 161a while having the information obtained by the information-obtaining unit 1101a and the target concentration ratio as inputs, and a motive power model for outputting the blow water amount. For example, the concentration ratio model and the motive power model are machine learning models such as neural network models, or simulation models.

The maximum concentration ratio determination unit 1111a determines the maximum concentration ratio by inputting the information obtained by the information-obtaining unit 1101a to the concentration ratio model stored in the model storage unit 1110a.

The motive power determination unit 1112a determines the plurality of target concentration ratios of equal to or lower than the maximum concentration ratio determined by the maximum concentration ratio determination unit 1111a. The motive power determination unit 1112a determines power of the third water feeding pump 1051a and power of the fan 161a related to each of the target concentration ratios, and the blow water amount based on the motive power model stored in the model storage unit 1110a. That is, the motive power determination unit 1112a determines power of the fan 161a based on the state quantity affecting the third water feeding pump 1051a obtained by the information-obtaining unit 1101a and determines power of the third water feeding pump 1051a based on the state quantity affecting the fan 161a.

The input unit 1113a receives an input of power of the third water feeding pump 1051a and power of the fan 161a from a user.

The updating unit 1114a updates a model stored in the model storage unit 1110a based on the information obtained by the information-obtaining unit 1101a and the information input to the input unit 1113a. For example, the updating unit 1114a can determine a relationship between the information obtained by the information-obtaining unit 1101a and the concentration ratio from the information obtained by the information-obtaining unit 1101a. Specifically, since the concentration ratio can be calculated from the circulating water amount obtained by the information-obtaining unit 1101a, the updating unit 1114a can update the concentration ratio model using a combination of the information obtained by the information-obtaining unit 1101a and the concentration ratio thereof.

In addition, for example, the updating unit 1114a can determine relationships between the information obtained by the information-obtaining unit 1101a, power of the fan 161a, power of the third water feeding pump 1051a, and the blow water amount from the information obtained by the information-obtaining unit 1101a. Specifically, the blow water amount can be calculated from the circulating water amount obtained by the information-obtaining unit 1101a. In addition, power of the fan 161a and power of the third water feeding pump 1051a can be calculated respectively from the fan power and pump electric power. Therefore, the updating unit 1114a can update the motive power model while having a combination of the information obtained by the information-obtaining unit 1101a, power of the fan 161a and power of the third water feeding pump 1051a, and the blow water amount thereof as the teaching data.

In addition, for example, the updating unit 1114a can update the motive power model based on the information obtained by the information-obtaining unit 1101a, and power of the fan 161a and power of the third water feeding pump 1051a input to the input unit 1113a.

<<Operation of Auxiliary-Machine Control Device>>

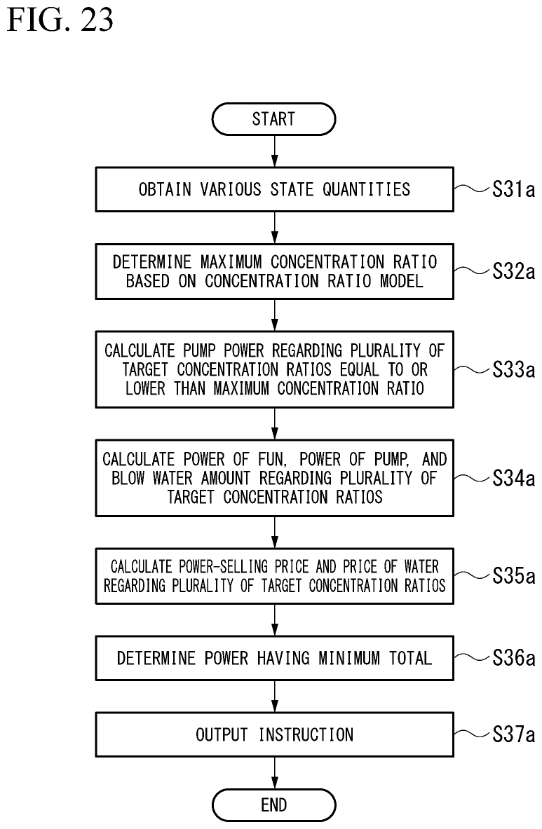

FIG. 23 is a flowchart showing an operation of the auxiliary-machine control device according to an embodiment.

The information-obtaining unit 1101a obtains fan power detected by the first wattmeter 162a, the cooling water quality index value detected by the cooling water quality sensor 1052a, the makeup water quality index value detected by the makeup water quality sensor 1062a, the circulating water amount detected by the circulating water amount sensor 1053a, the cooling tower inlet water temperature detected by the cooling tower inlet water temperature sensor 1054a, the cooling tower outlet water temperature detected by the cooling tower outlet water temperature sensor 1055a, pump electric power detected by the second wattmeter 1056a, the wet-bulb temperature measured by the environment measurement device 111a, and generated electric power measured by the operation-monitoring device 112a (Step S31a).

Next, the maximum concentration ratio determination unit 1111a determines the maximum concentration ratio by inputting the information obtained by the information-obtaining unit 1101a to the concentration ratio model stored in the model storage unit 1110a (Step S32a). Next, the motive power determination unit 1112a determines the plurality of concentration ratios equal to or lower than the maximum concentration ratio determined by the maximum concentration ratio determination unit 1102a as the target concentration ratios (Step S33a). Next, the motive power determination unit 1112a determines power of the third water feeding pump 1051a, power of the fan 161a, and the blow water amount by inputting the information obtained by the information-obtaining unit 1101a and the target concentration ratio thereof to the motive power model stored in the model storage unit 1110a for each of the determined target concentration ratios (Step S34a).

The determination unit 1106a calculates the power-selling price of electric power consumed by the third water feeding pump 1051a related to each of the target concentration ratios, the power-selling price of electric power consumed by the fan 161a related to each of the target concentration ratios, and the price of water supplied from the water source related to each of the target concentration ratios based on the information stored in the price storage unit 1108a (Step S35a). The determination unit 1106a determines a prices in which the sum of the power-selling price of electric power and the price of water becomes the minimum and determines power of the third water feeding pump 1051a and power of the fan 161a related to the target concentration ratio thereof as the power of the third water feeding pump 1051a and the power of the fan 161a (Step S36a). The output unit 1107a outputs an instruction to the third water feeding pump 1051a and the fan 161a to be operated with power determined by the determination unit 1106a (Step S37a). Accordingly, the third water feeding pump 1051a and the fan 161a can be operated such that expense is reduced while the water quality inside the cooling water circulating line 105a is maintained at a certain level or higher.

<<Operations and Effects>>

In this manner, according to the ninth embodiment, since the concentration ratio model and the motive power model are updated by the updating unit 1114a, the auxiliary-machine control device 110a can appropriately determine power of the auxiliary machine even when characteristics of the power plant 10a change due to deterioration or the like.

Hereinabove, embodiments have been described in detail with reference to the drawings. However, a specific constitution is not limited to those described above, and various design changes and the like can be made.

For example, in the embodiments described above, the auxiliary-machine control device 110a determines power of the fan 161a and power of the third water feeding pump 1051a, but it is not limited thereto. For example, in other embodiments, in addition to or in place of the fan 161a and the third water feeding pump 1051a, power of a different auxiliary machine such as the first water feeding pump 1011a may be determined.

In addition, in the embodiments described above, the auxiliary-machine control device 110a controlling an auxiliary machine has been described as an example of an auxiliary-machine power determining unit, but it is not limited thereto. For example, in other embodiments, in place of the auxiliary-machine control device 110a, the power plant 10a may include an auxiliary-machine power determining unit causing a display or the like to display calculated power without directly controlling the auxiliary machine. In this case, an operator visually recognizes an output value and controls the auxiliary machine.

### Tenth Embodiment

A performance of a cooling tower is designed at the time of manufacturing, and a cooling tower is controlled based on such a rated performance. Meanwhile, the inventor has acquired knowledge that the performance of a wet cooling tower deteriorates over time. Until now, it has not been known that a wet cooling tower deteriorates over time, and therefore an instrument for measuring the state is not provided in a wet cooling tower sometimes.

Therefore, the water treatment system according to a tenth embodiment appropriately evaluates a degradation state of the performance of a wet cooling tower.

<<Constitution of Water Treatment System>>

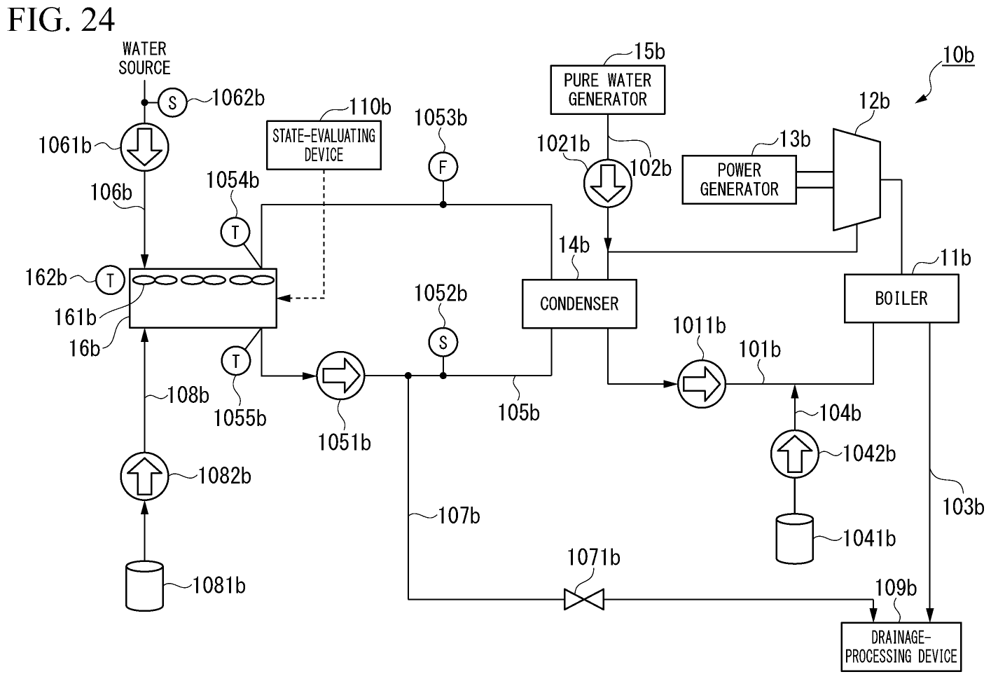

FIG. 24 is a schematic block diagram illustrating a constitution of the power plant according to an embodiment.

A power plant 10b includes a boiler 11b, a steam turbine 12b, a power generator 13b, a condenser 14b, a pure water generator 15b, a wet cooling tower 16b, a steam circulating line 101b, a first supply line 102b, a first drainage line 103b, a first chemical feed line 104b, a cooling water circulating line 105b, a second supply line 106b, a second drainage line 107b, a second chemical feed line 108b, a drainage-processing device 109b, and a state-evaluating device 110b.

The boiler 11b generates steam by evaporating water.

The steam turbine 12b rotates due to steam generated by the boiler 11b.

The power generator 13b converts rotation energy of the steam turbine 12b into electric power.

The condenser 14b performs heat exchange between steam discharged from the steam turbine 12b and the cooling water, such that steam returns to water.

The pure water generator 15b generates pure water.

The wet cooling tower 16b cools the cooling water subjected to heat exchange in the condenser 14b. A fan 161b for urging the cooling water to be evaporated, and a wet-bulb thermometer 162b for measuring the wet-bulb temperature in the vicinity of the wet cooling tower 16b are provided in the wet cooling tower 16b. The fan 161b is constituted such that the air volume can be adjusted by controlling the number of fans and controlling the inverter.

The steam circulating line 101b is a line for causing water and steam to circulate in the steam turbine 12b, the condenser 14b, and the boiler 11b. A first water feeding pump 1011b is provided between the condenser 14b and the boiler 11b in the steam circulating line 101b. The first water feeding pump 1011b pressure-feeds water from the condenser 14b toward the boiler 11b.

The first supply line 102b is a line for supplying pure water generated by the pure water generator 15b to the steam circulating line 101b. A second water feeding pump 1021b is provided in the first supply line 102b. The second water feeding pump 1021b is used at the time of filling the condenser 14b with water. During operation, water inside the first supply line 102b is pressure-fed from the pure water generator 15b toward the condenser 14b due to decompression of the condenser 14b.

The first drainage line 103b is a line for discharging a part of water circulating in the steam circulating line 101b from the boiler 11b to the drainage-processing device 109b.

The first chemical feed line 104b is a line for supplying a chemical such as a corrosion preventive agent, a scaling preventive agent, or a slime control agent to the steam circulating line 101b. The first chemical feed line 104b includes a first chemical tank 1041b retaining a chemical, and a first chemical feed pump 1042b supplying the chemical from the first chemical tank 1041b to the steam circulating line 101b.

The cooling water circulating line 105b is a line for causing the cooling water to circulate in the condenser 14b and the wet cooling tower 16b. A third water feeding pump 1051b, a cooling water quality sensor 1052b, a circulating water amount sensor 1053b, a cooling tower inlet water temperature sensor 1054b, and a cooling tower outlet water temperature sensor 1055b are provided in the cooling water circulating line 105b. The third water feeding pump 1051b pressure-feeds the cooling water from the wet cooling tower 16b toward the condenser 14b.

The cooling water quality sensor 1052b detects the water quality of the cooling water circulating in the cooling water circulating line 105b. Examples of the water quality detected by the sensor include an electrical conductivity, a pH value, a salt concentration, a metal concentration, a chemical oxygen demand (COD), a biochemical oxygen demand (BOD), a microbial concentration, a silica concentration, and combinations of these. The cooling water quality sensor 1052b outputs the circulating water quality index value indicating the detected water quality to the state-evaluating device 110b. The circulating water amount sensor 1053b detects the flow rate of the cooling water circulating in the cooling water circulating line 105b. The circulating water amount sensor 1053b outputs the circulating water amount indicating the detected water amount to the state-evaluating device 110b. The cooling tower inlet water temperature sensor 1054b detects the temperature of the cooling water added to the wet cooling tower 16b. The cooling tower inlet water temperature sensor 1054b outputs the cooling tower inlet water temperature indicating the detected temperature to the state-evaluating device 110b. The cooling tower outlet water temperature sensor 1055b detects the temperature of the cooling water discharged from the wet cooling tower 16b. The cooling tower outlet water temperature sensor 1055b outputs the cooling tower outlet water temperature indicating the detected temperature to the state-evaluating device 110b.

The second supply line 106b is a line for supplying raw water taken from the water source to the cooling water circulating line 105b as makeup water. A fourth water feeding pump 1061b and a makeup water quality sensor 1062b are provided in the second supply line 106b. The fourth water feeding pump 1061b pressure-feeds the makeup water from the water source toward the wet cooling tower 16b. The makeup water quality sensor 1062b outputs the makeup water quality index value indicating the detected water quality to the state-evaluating device 110b.

The second drainage line 107b is a line for discharging a part of water circulating in the cooling water circulating line 105b to the drainage-processing device 109b. A blow valve 1071b and a drainage water quality sensor 1072b are provided in the second drainage line 107b. The blow valve 1071b restricts the amount of the drainage water to be blown from the cooling water circulating line 105b to the drainage-processing device 109b.

The second chemical feed line 108b is a line for supplying a chemical to the cooling water circulating line 105b. The second chemical feed line 108b includes a second chemical tank 1081b retaining a chemical, and a second chemical feed pump 1082b supplying a chemical from the second chemical tank 1081b to the cooling water circulating line 105b.

The drainage-processing device 109b feeds an acid, an alkali, a flocculant, or other chemicals into the drainage water discharged from the first drainage line 103b and the second drainage line 107b. The drainage-processing device 109b discards the drainage water processed using the chemical.

The state-evaluating device 110b evaluates the degradation state of the performance of the wet cooling tower 16b based on the wet-bulb temperature detected by the wet-bulb thermometer 162b, the cooling tower inlet water temperature detected by the cooling tower inlet water temperature sensor 1054b, and the cooling tower outlet water temperature detected by the cooling tower outlet water temperature sensor 1055b.

<<Constitution of State-Evaluating Device>>

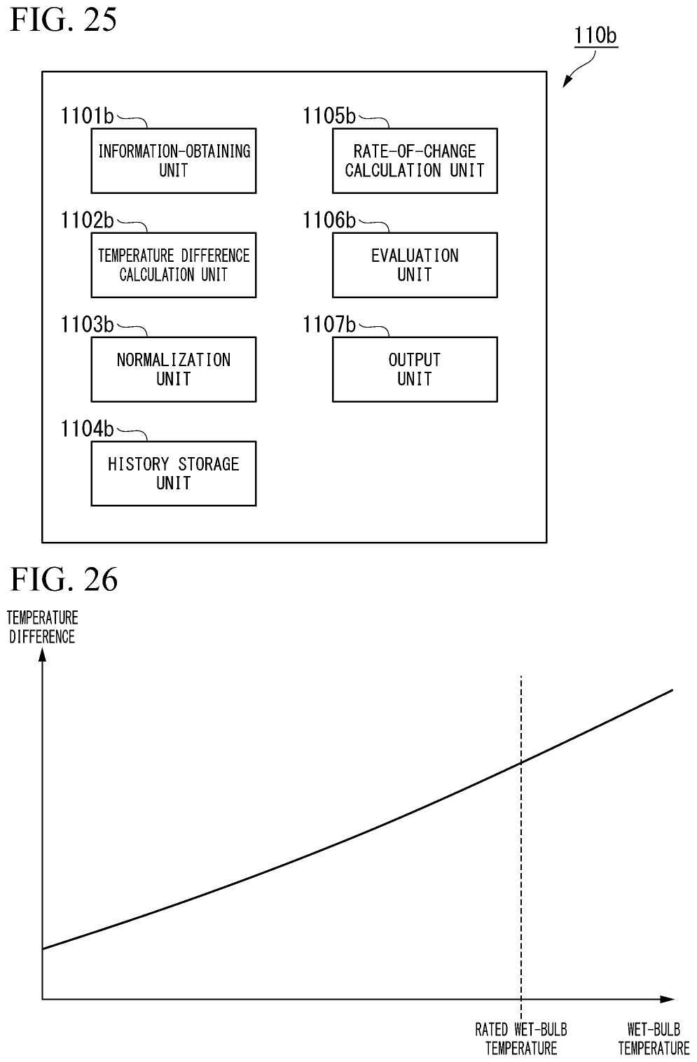

FIG. 25 is a schematic block diagram illustrating a constitution of a state-evaluating device according to an embodiment.

The state-evaluating device 110b includes an information-obtaining unit 1101b, a temperature difference calculation unit 1102b, a normalization unit 1103b, a history storage unit 1104b, a rate-of-change calculation unit 1105b, an evaluation unit 1106b, and an output unit 1107b.

The information-obtaining unit 1101b obtains the wet-bulb temperature of the atmosphere detected by the wet-bulb thermometer 162b, the cooling tower inlet water temperature detected by the cooling tower inlet water temperature sensor 1054b, and the cooling tower outlet water temperature detected by the cooling tower outlet water temperature sensor 1055b.

The temperature difference calculation unit 1102b calculates a temperature difference between a cooling tower inlet temperature and a cooling tower outlet temperature.

The normalization unit 1103b calculates a normalized temperature difference realized by normalizing the temperature difference based on the wet-bulb temperature of the atmosphere. That is, the normalization unit 1103b calculates the normalized temperature difference which is a temperature difference in a specific wet-bulb temperature (for example, a rated wet-bulb temperature) based on a known rated performance function, the wet-bulb temperature, and the temperature difference between the cooling tower inlet temperature and the cooling tower outlet temperature. A rated performance function is a function designed at the time of manufacturing the wet cooling tower 16b as the rated performance of the wet cooling tower 16b and expresses a relationship between the wet-bulb temperature and the temperature difference between the cooling tower inlet temperature and the cooling tower outlet temperature. FIG. 26 is a view illustrating an example of a rated performance function. In the rated performance function, the temperature difference between the cooling tower inlet temperature and the cooling tower outlet temperature increases monotonously regarding the wet-bulb temperature. For example, the normalization unit 1103b can calculate the normalized temperature difference by obtaining a ratio of the temperature difference obtained by substituting the measured wet-bulb temperature into the rated performance function and the temperature difference related to the rated wet-bulb temperature and multiplying the measured temperature difference between the cooling tower inlet temperature and the cooling tower outlet temperature by the ratio thereof.

The history storage unit 1104b stores the normalized temperature difference in association with the time.

The rate-of-change calculation unit 1105b calculates a rate of change in normalized temperature difference based on a history of the normalized temperature difference calculated by the normalization unit 1103b and the normalized temperature difference stored in the history storage unit 1104b. For example, the rate-of-change calculation unit 1105b can calculate the rate of change by differentiating the time series of the normalized temperature difference.

The evaluation unit 1106b evaluates the degradation state of the performance of the wet cooling tower 16b based on the rate of change in normalized temperature difference and normalized temperature difference. Specifically, when the rate of change in normalized temperature difference is equal to or larger than a specific threshold of the rate of change, the evaluation unit 1106b determines that degradation of the performance has occurred due to disruption. In addition, when the rate of change in normalized temperature difference is smaller than a specific threshold, the evaluation unit 1106b determines that degradation of the performance has occurred due to deterioration. Here, examples of deterioration of the wet cooling tower 16b include degradation of a heat exchange rate due to occurrence of scaling or fouling inside the wet cooling tower 16b. In addition, examples of disruption of the wet cooling tower 16b include incorporation of a foreign substance and damage to the wet cooling tower 16b. In addition, the evaluation unit 1106b determines whether or not the degradation of the performance is allowable by determining whether or not the normalized temperature difference is smaller than a specific temperature difference threshold.

For example, the temperature difference threshold is set to a value such that the sum of the cost related to a power-selling income and cleaning obtained for the time required for cleaning the wet cooling tower 16b, and the amount of electric power loss due to the performance degradation corresponding to the value of the temperature difference threshold thereof become equivalent to each other. Due to the value set in such a manner, when the normalized temperature difference of the wet cooling tower 16b is equal to or larger than the temperature difference threshold, the sum of the cost related to the power-selling income and cleaning obtained for the time required for cleaning the wet cooling tower 16b becomes equal to or lower than the amount of electric power loss due to the performance degradation. On the other hand, when the normalized temperature difference of the wet cooling tower 16b is smaller than the temperature difference threshold, the sum of the cost related to the power-selling income and cleaning obtained for the time required for cleaning the wet cooling tower 16b becomes larger than the amount of electric power loss due to the performance degradation.

The output unit 1107b outputs information based on the degradation state of the performance evaluated by the evaluation unit 1106b. For example, when it is evaluated that degradation of the performance has occurred in the evaluation unit 1106b due to disruption and the normalized temperature difference is smaller than the specific threshold, the output unit 1107b outputs the fact that disruption has occurred and inspection is recommended. In addition, for example, when it is evaluated that degradation of the performance has occurred in the evaluation unit 1106b due to deterioration and the normalized temperature difference is smaller than the specific threshold, the output unit 1107b outputs the fact that the performance has been degraded due to deterioration and cleaning of the wet cooling tower 16b or replacement of a component is recommended. For example, outputting performed by the output unit 1107b may be transmitting of information to a computer carried by a manager via a network, or may be displaying of information in a display.

<<Operation of State-Evaluating Device>>

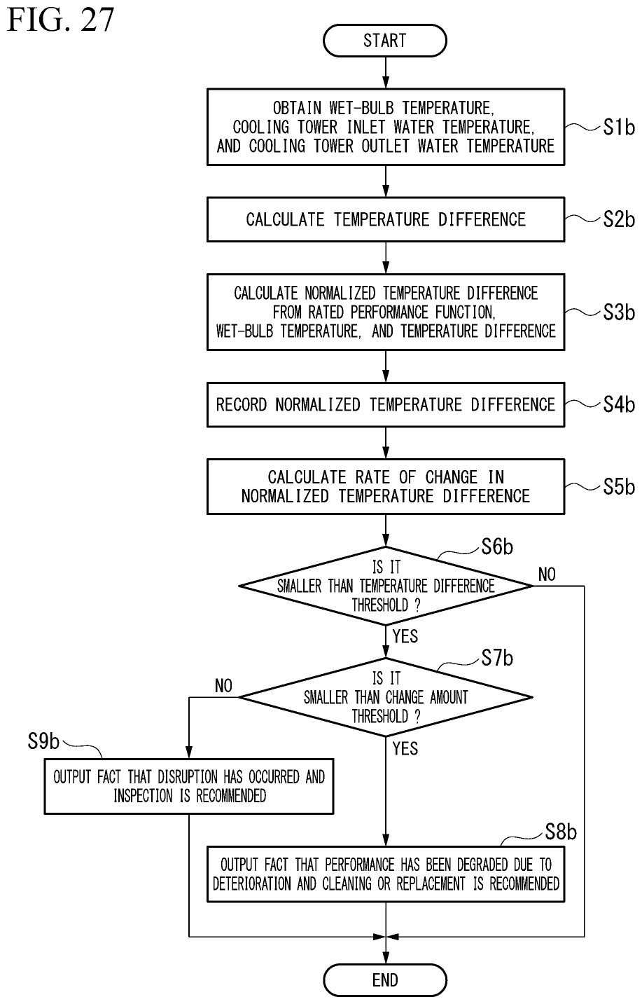

FIG. 27 is a flowchart showing an operation of the state-evaluating device according to an embodiment.

The state-evaluating device 110b regularly executes a state-evaluating process illustrated in FIG. 26. First, the information-obtaining unit 1101b obtains the wet-bulb temperature of the atmosphere detected by the wet-bulb thermometer 162b, the cooling tower inlet water temperature detected by the cooling tower inlet water temperature sensor 1054b, and the cooling tower outlet water temperature detected by the cooling tower outlet water temperature sensor 1055b (Step S1b). The temperature difference calculation unit 1102b calculates the temperature difference between the cooling tower inlet temperature and the cooling tower outlet temperature (Step S2b).

The normalization unit 1103b calculates the normalized temperature difference based on a known rated performance function, the wet-bulb temperature, and the temperature difference between the cooling tower inlet temperature and the cooling tower outlet temperature (Step S3b). The normalization unit 1103b records the calculated normalized temperature difference in the history storage unit 1104b in association with the current time (Step S4b). The rate-of-change calculation unit 1105b calculates the rate of change in normalized temperature difference based on the time series of the normalized temperature difference stored in the history storage unit 1104b (Step S5b).

The evaluation unit 1106b determines whether or not the normalized temperature difference is smaller than the specific temperature difference threshold (Step S6b). When the normalized temperature difference is equal to or larger than the temperature difference threshold (Step S6b: NO), the evaluation unit 1106b evaluates that the performance of the wet cooling tower 16b has not been degraded or the degradation state of the performance of the wet cooling tower 16b is allowable, thereby ending the processing.

On the other hand, when the normalized temperature difference is smaller than the temperature difference threshold (Step S6b: YES), the evaluation unit 1106b determines whether or not an absolute value of the rate of change in normalized temperature difference is smaller than a specific change amount threshold (Step S7b).

When the absolute value of the rate of change in normalized temperature difference is smaller than the specific threshold (Step S7b: YES), the evaluation unit 1106b evaluates that degradation of the performance of the wet cooling tower 16b has occurred due to deterioration. In this case, the output unit 1107b outputs the fact that the performance has been degraded due to deterioration of the wet cooling tower 16b and cleaning of the wet cooling tower 16b or replacement of a component is recommended (Step S8b).

On the other hand, when the rate of change in normalized temperature difference is equal to or larger than the specific threshold (Step S7b: NO), the evaluation unit 1106b evaluates that degradation of the performance of the wet cooling tower 16b has occurred due to disruption. In this case, the output unit 1107b outputs the fact that disruption has occurred in the wet cooling tower 16b and inspection of the wet cooling tower 16b is recommended (Step S9b).

<<Operations and Effects>>

In this manner, the state-evaluating device 110b according to the tenth embodiment evaluates the degradation state of the performance of the wet cooling tower 16b based on the cooling tower inlet temperature, the cooling tower outlet temperature, and the wet-bulb temperature of the atmosphere. Accordingly, since the state-evaluating device 110b can quantify the current performance of the wet cooling tower 16b, the degradation state of the performance of the wet cooling tower 16b can be appropriately evaluated. In addition, since the state-evaluating device 110b regularly evaluates the degradation state of the performance, a manager of the power plant 10b can monitor the degradation state of the performance of the wet cooling tower 16b and measure a timing for appropriate action.

In addition, the state-evaluating device 110b according to the tenth embodiment determines whether degradation of the performance of the wet cooling tower 16b has occurred due to deterioration or disruption based on the cooling tower inlet temperature, the cooling tower outlet temperature, and the wet-bulb temperature of the atmosphere. Accordingly, the manager of the power plant 10b can take action in accordance with the reason for the deterioration in performance of the wet cooling tower 16b.

Particularly, the state-evaluating device 110b according to the tenth embodiment determines necessity of cleaning of the wet cooling tower 16b, necessity of replacement of a component, and necessity of inspection based on the degradation state of the performance of the wet cooling tower 16b. Accordingly, the manager of the power plant 10b can take appropriate action in accordance with the reason for the deterioration in performance of the wet cooling tower 16b.

<<Modification Example>>

The evaluation unit 1106b of the state-evaluating device 110b according to the tenth embodiment evaluates whether degradation of the performance has occurred due to disruption or deterioration by determining whether or not the absolute value of the rate of change in normalized temperature difference is smaller than the specific threshold, but it is not limited thereto. For example, the evaluation unit 1106b according to other embodiments may evaluate that degradation of the performance has occurred due to disruption when a second-order differential value of the normalized temperature difference is a positive number and may evaluate that degradation of the performance has occurred due to deterioration when the second-order differential value of the normalized temperature difference is not a positive number. The reason is that when degradation of the performance of the wet cooling tower 16b has occurred due to deterioration, the rate of change in normalized temperature difference is reduced over time, whereas when degradation of the performance of the wet cooling tower 16b has occurred due to disruption, the state of the wet cooling tower 16b changes suddenly so that the rate of change in normalized temperature difference increases temporarily.

### Eleventh Embodiment

When the performance has degraded due to deterioration of the wet cooling tower 16b, the manager can recover the performance of the wet cooling tower 16b by cleaning the wet cooling tower 16b or replacing a component.

When a component of the wet cooling tower 16b is replaced, there is a need to stop the wet cooling tower 16b for a long time compared to cleaning of the wet cooling tower 16b, and an extra cost is incurred as much as the expense for replacing a component and a personnel expense. On the other hand, when a component of the wet cooling tower 16b is replaced, the performance of the wet cooling tower 16b can be further improved by attempting upgrading of the component.

When cleaning of the wet cooling tower 16b is performed, the performance of the wet cooling tower 16b can be recovered in a short time and at low cost compared to replacement of a component. On the other hand, depending on the state of the wet cooling tower 16b, the performance may not be able to be recovered sufficiently by cleaning the wet cooling tower 16b.

The state-evaluating device 110b according to an eleventh embodiment presents whether to clean the wet cooling tower 16b or to replace a component, based on the state of the wet cooling tower 16b.

<<Constitution of State-Evaluating Device>>

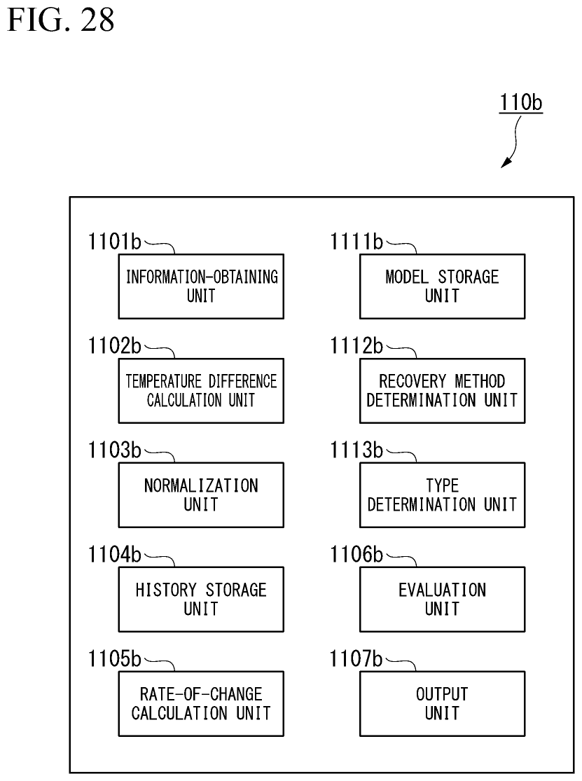

FIG. 28 is a schematic block diagram related to a constitution of the state-evaluating device according to an embodiment.

The state-evaluating device 110b according to the eleventh embodiment further includes a model storage unit 1111b, a recovery method determination unit 1112b, and a type determination unit 1113b, in addition to the constituents of the tenth embodiment. In addition, the information-obtaining unit 1101b according to the eleventh embodiment further obtains the makeup water quality index value measured by the makeup water quality sensor 1062b, the cooling water quality index value measured by the cooling water quality sensor 1052b, and the circulating water amount measured by the circulating water amount sensor 1053b, in addition to the state quantity obtained in the tenth embodiment.

The model storage unit 1111b stores a model for outputting a recovery method for the performance of the wet cooling tower 16b while having the wet-bulb temperature, the cooling tower inlet water temperature, the cooling tower outlet water temperature, the makeup water quality index value, the cooling water quality index value, and the circulating water amount as inputs. For example, the model is a machine learning model such as a neural network. The recovery method for the performance according to the eleventh embodiment is cleaning or replacement of a component.

In a process of learning a model, for example, a model can be learned by the following technique. When cleaning of the wet cooling tower 16b is required for an actual machine, the manager of the power plant 10b measures combinations of the foregoing state quantities at the time, the time required for cleaning of the wet cooling tower 16b, and the interval from the timing of completion of cleaning to the timing requiring next cleaning. The manager calculates an actual power-selling price after cleaning by subtracting the cost related to the amount of loss incurred by stopping the power plant 10b during the time required for cleaning of the wet cooling tower 16b and cleaning from the power-selling price of the power plant 10b during the interval after cleaning.

On the other hand, the manager calculates the cost required when a component of the wet cooling tower 16b is replaced, the time required for replacement of a component, and the interval to the timing requiring next cleaning after replacement. The manager calculates an actual power-selling price after replacement by subtracting the cost related to the amount of loss incurred by stopping the power plant 10b during the time required for replacement of a component and replacement from the power-selling price of the power plant 10b during the interval after replacement.

When the actual power-selling price after cleaning exceeds the actual power-selling price after replacement, the manager generates teaching data in which a combination of the foregoing state quantities and information indicating that the recovery method for the performance is cleaning are associated with each other, and causes a model to be learned based on the teaching data.

When the actual power-selling price after cleaning falls below the actual power-selling price after replacement, the manager generates teaching data in which a combination of the foregoing state quantities and information indicating that the recovery method for the performance is replacement are associated with each other, and causes a model to be learned based on the teaching data.

The foregoing teaching data is not necessarily generated based on the processing for an actual machine. For example, the teaching data may be generated automatically by a computer through calculation based on a simulation of deterioration of the wet cooling tower 16b in the power plant 10b.

The recovery method determination unit 1112b determines the recovery method for the performance of the wet cooling tower 16b by inputting each of the state quantities obtained by the information-obtaining unit 1101b to a model stored in the model storage unit 1111b. That is, the recovery method determination unit 1112b determines whether to clean the wet cooling tower 16b or to replace a component based on the degradation state of the performance.

When the recovery method determination unit 1112b determines that a component is to be replaced, the type determination unit 1113b determines the kind of component to be replaced based on the makeup water quality index value obtained by the information-obtaining unit 1101b. Examples of a component (replacement target) include a nozzle and a filler. When the nozzle has a higher refinement performance, improvement in cooling efficiency of the wet cooling tower 16b is expected, whereas clogging is likely to occur due to deterioration. In addition, when the filler has a wider surface area as that of a film filler, improvement in cooling efficiency of the wet cooling tower 16b is expected, whereas clogging is likely to occur due to deterioration. On the other hand, when the filler has a narrower surface area as that of a splash filler, the improvement rate of the cooling efficiency of the wet cooling tower 16b is low, whereas clogging is unlikely to occur due to deterioration.

Accordingly, when the makeup water quality index value is equal to or larger than a specific water quality threshold (favorable), the type determination unit 1113b determines a nozzle having a high refinement performance and a filler having a wide surface area as the kind of component to be replaced. On the other hand, when the makeup water quality index value is smaller than the specific water quality threshold (poor), the type determination unit 1113b determines a nozzle having a low refinement performance and a filler having a narrow surface area as the kind of component to be replaced.

<<Operation of State-Evaluating Device>>

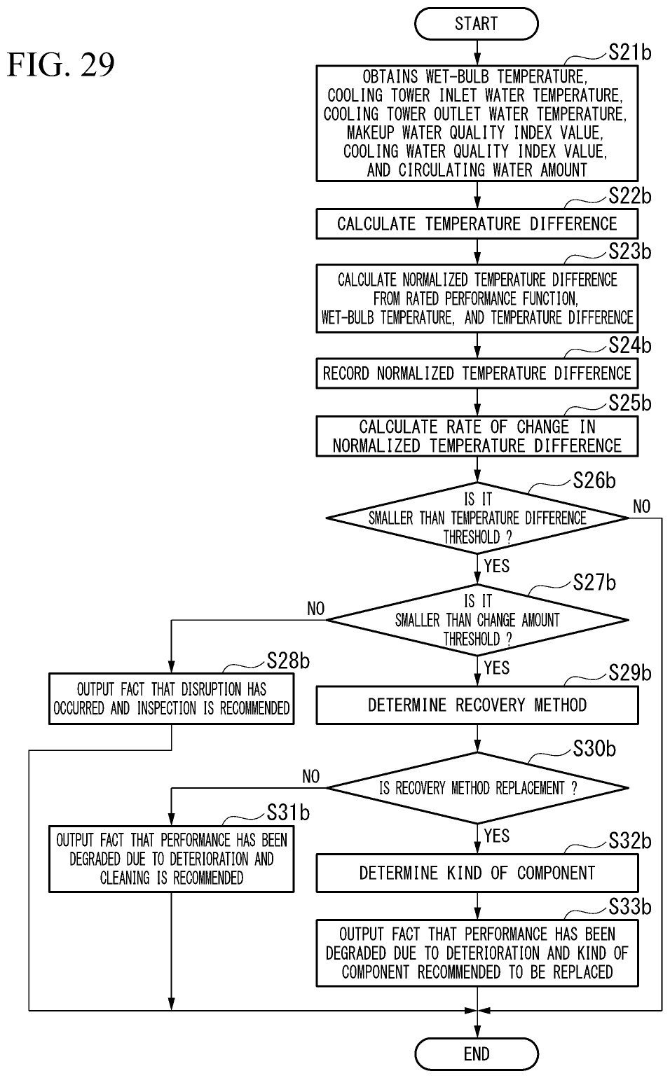

FIG. 29 is a flowchart showing an operation of the state-evaluating device according to an embodiment.

The state-evaluating device 110b according to the eleventh embodiment regularly executes the state-evaluating process illustrated in FIG. 29. First, the information-obtaining unit 1101b obtains the wet-bulb temperature, the cooling tower inlet water temperature, the cooling tower outlet water temperature, the makeup water quality index value, the cooling water quality index value, and the circulating water amount (Step S21b). The temperature difference calculation unit 1102b calculates the temperature difference between the cooling tower inlet temperature and the cooling tower outlet temperature (Step S22b).

The normalization unit 1103b calculates the normalized temperature difference based on a known rated performance function, the wet-bulb temperature, and the temperature difference between the cooling tower inlet temperature and the cooling tower outlet temperature (Step S23b). The normalization unit 1103b records the calculated normalized temperature difference in the history storage unit 1104b in association with the current time (Step S24b). The rate-of-change calculation unit 1105b calculates the rate of change in normalized temperature difference based on the time series of the normalized temperature difference stored in the history storage unit 1104b (Step S25b).

The evaluation unit 1106b determines whether or not the normalized temperature difference is smaller than the specific temperature difference threshold (Step S26b). When the normalized temperature difference is equal to or larger than the temperature difference threshold (Step S26b: NO), the evaluation unit 1106b evaluates that the performance of the wet cooling tower 16b has not been degraded or the degradation state of the performance of the wet cooling tower 16b is allowable, thereby ending the processing.

On the other hand, when the normalized temperature difference is smaller than the temperature difference threshold (Step S26b: YES), the evaluation unit 1106b determines whether or not the absolute value of the rate of change in normalized temperature difference is smaller than the specific change amount threshold (Step S27b).

When the rate of change in normalized temperature difference is equal to or larger than the specific threshold (Step S27b: NO), the evaluation unit 1106b evaluates that degradation of the performance of the wet cooling tower 16b has occurred due to disruption. In this case, the output unit 1107b outputs the fact that disruption has occurred in the wet cooling tower 16b and inspection of the wet cooling tower 16b is recommended (Step S28b).

On the other hand, when the absolute value of the rate of change in normalized temperature difference is smaller than the specific threshold (Step S27b: YES), the recovery method determination unit 1112b determines the recovery method for the performance by inputting the state quantity obtained in Step S21b to a model stored in the model storage unit 1111b (Step S29b). The type determination unit 1113b determines whether or not the recovery method determined by the recovery method determination unit 1112b is replacement of a component (Step S30b). When the recovery method determined by the recovery method determination unit 1112b is cleaning (Step S30b: NO), the output unit 1107b outputs the fact that the performance has been degraded due to deterioration of the wet cooling tower 16b and cleaning of the wet cooling tower 16b is recommended (Step S31b).

When the recovery method determined by the recovery method determination unit 1112b is replacement of a component (Step S30b: YES), the type determination unit 1113b determines the kind of component to be replaced based on the makeup water quality index value obtained in Step S21b (Step S32b). The output unit 1107b outputs the fact that the performance has been degraded due to deterioration of the wet cooling tower 16b and replacement of the component of the kind determined by the type determination unit 1113b is recommended (Step S33b).

<<Operations and Effects>>

In this manner, the state-evaluating device 110b according to the eleventh embodiment determines whether to replace a component or to perform cleaning based on the state quantity of the wet cooling tower 16b. Accordingly, the manager of the power plant 10b can take appropriate action for recovering the performance of the wet cooling tower 16b. Particularly, in the eleventh embodiment, since the recovery method can be determined based on the profit and loss related to replacement of a component and the profit and loss related to cleaning of a component, the presented recovery method becomes a recovery method in which the loss is minimized.

In addition, the state-evaluating device 110b according to the eleventh embodiment determines the kind of component to be replaced based on the makeup water quality index value. Accordingly, the state-evaluating device 110b can propose upgrading of a component corresponding to the water quality of the makeup water at the time of replacement.

Hereinabove, embodiments have been described in detail with reference to the drawings. However, a specific constitution is not limited to those described above, and various design changes and the like can be made.

For example, the state-evaluating device 110b according to the embodiment described above determines whether the performance degradation has occurred due to disruption or deterioration based on the normalized temperature difference, but it is not limited thereto. For example, the state-evaluating device 110b may determine whether the performance degradation has occurred due to disruption or deterioration by inputting information obtained by the information-obtaining unit 1101b to a trained model.

### Twelfth Embodiment

Hereinafter, a thermal power plant 1c of a twelfth embodiment will be described.

Power plants are required to have improved power generation efficiency, and various studies for reducing exhaust heat have been carried out. However, in current circulating boilers, exhaust heat has not been able to be sufficiently utilized through discharging of drum water.

Therefore, in the thermal power plant 1c of the twelfth embodiment, the efficiency is further improved utilizing exhaust heat.

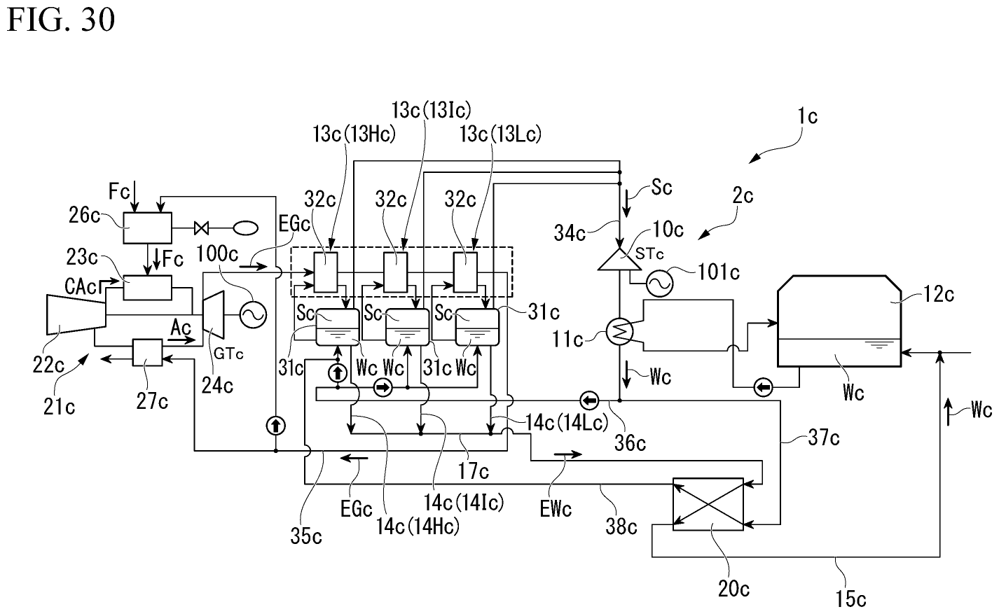

As illustrated in FIG. 30, the thermal power plant 1c includes a circulating boiler system 2c having a steam turbine 10c driven by steam Sc, a condenser 11c, a cooling tower 12c, a circulating boiler 13c introducing the steam Sc into the steam turbine 10c, a blow pipe 14c connected to the circulating boiler 13c, a heat exchanger 20c connected to the blow pipe 14c, and a cooling tower introduction pipe 15c connecting the heat exchanger 20c and the cooling tower 12c to each other. Moreover, the thermal power plant 1c includes a gas turbine 21c introducing exhaust gas EGc into the circulating boiler 13c.

The gas turbine 21c has a compressor 22c, a combustor 23c, and a turbine 24c (detailed illustration is omitted). Fuel Fc and compressed air CAc generated by the compressor 22c are combusted in the combustor 23c, and the turbine 24c is driven by introducing high-temperature/high-pressure gas into the turbine 24c. Accordingly, a power generator 100c is rotated, and thus power generation is performed.

A heater 26c for preheating the fuel Fc to be introduced into the combustor 23c is provided in the combustor 23c.

An air cooler 27c for cooling extracted air Ac is provided in the compressor 22c. After the extracted air Ac is cooled by the air cooler 27c, it is introduced into the turbine 24c, and a high-temperature component is cooled or the like. The air cooler 27c is not necessarily provided.

A diffuser (not illustrated) is provided in the turbine 24c. The exhaust gas EGc is discharged from this diffuser.

The steam turbine 10c is driven by the steam Sc and rotates a power generator 101c, thereby performing power generation.

The condenser 11c is connected to the steam turbine 10c and condenses the steam (exhaust steam) Sc from the steam turbine 10c to obtain water Wc.

The cooling tower 12c is connected to the condenser 11c, and the water Wc (fluid) circulates between the cooling tower 12c and the condenser 11c. The steam Sc inside the condenser 11c is condensed, and the water Wc is generated from the steam Sc by the condenser 11c.

The circulating boiler 13c is a so-called natural circulation or forced circulation boiler having a boiler main body 31c and an evaporator 32c connected to the boiler main body 31c. The circulating boiler 13c of the present embodiment is a drum boiler.

The boiler main body 31c retains the water Wc (condensed fluid) and the steam Sc. In addition, the boiler main body 31c and the steam turbine 10c are connected to each other through a steam introduction pipe 34c, such that the steam Sc inside the boiler main body 31c can be introduced into the steam turbine 10c.

The evaporator 32c is connected to the turbine 24c and performs heat exchange between the exhaust gas EGc from the turbine 24c and the water Wc in the boiler main body 31c. The evaporator 32c heats the water Wc such that it returns to the boiler main body 31c as the steam Sc.

Here, in the present embodiment, as the circulating boiler 13c, a high pressure boiler 13Hc, a medium pressure boiler 131c, and a low pressure boiler 13Lc for evaporating the water Wc from the condenser 11c are provided in parallel to each other. The exhaust gas EGc in the gas turbine 21c is introduced into the evaporator 32c of each of the boilers 13c in the order of the high pressure boiler 13Hc, the medium pressure boiler 131c, and the low pressure boiler 13Lc. That is, the exhaust gas EGc circulates in the evaporator 32c of each of the boilers 13c in series.

An exhaust gas pipe 35c is connected to the evaporator 32c in the low pressure boiler 13Lc. In the present embodiment, the exhaust gas pipe 35c is bifurcated downstream in the evaporator 32c and is connected to the heater 26c and the air cooler 27c. Accordingly, the exhaust gas EGc which has passed through the evaporator 32c is used for preheating the fuel Fc in the heater 26c and preheating the air Ac extracted from the compressor 22c. After the fuel Fc and the air Ac are preheated, the exhaust gas EGc is discharged to the outside of the system.

The boiler main body 31c in each of the boilers 13c and the condenser 11c are connected to each other by a boiler pipe 36c. The boiler pipe 36c is trifurcated in the middle and is connected to the boiler main body 31c in each of the boilers 13c. Accordingly, the water Wc from the condenser 11c is introduced into the boiler main body 31c in each of the boilers 13c in parallel.

The blow pipe 14c is connected to the boiler main body 31c in each of the boilers 13c and discharges a part of the water Wc inside the boiler main body 31c as drainage water EWc (discharging fluid). In the present embodiment, as the blow pipe 14c, a high pressure blow pipe 14Hc provided in the high pressure boiler 13Hc, a medium pressure blow pipe 14Lc provided in the medium pressure boiler 13Lc, and a low pressure blow pipe 14Lc provided in the low pressure boiler 13Lc are provided. In addition, the blow pipes 14c in the boilers 13c are connected to each other through a joining pipe 17c and collectively send the drainage water EWc from each of the blow pipes 14c to the downstream side.

The heat exchanger 20c is connected to the joining pipe 17c such that the drainage water EWc from each of the blow pipes 14c can be introduced. In addition, the heat exchanger 20c is connected to a heat exchange pipe 37c bifurcating from an intermediate position between the condenser 11c and the boiler main body 31c in the boiler pipe 36c. Accordingly, the water Wc directed toward the circulating boiler 13c from the condenser 11c can be introduced into the heat exchanger 20c. Further, the heat exchanger 20c performs heat exchange between the drainage water EWc from each of the blow pipes 14c and the water Wc from the condenser 11c, and heats the water Wc by performing heat recovery in the water Wc (exhaust heat recovery step), thereby cooling the drainage water EWc. The water Wc which has been subjected to heat exchange in the heat exchanger 20c is introduced into the boiler main body 31c in the high pressure boiler 13Hc through a preheating water pipe 38c connecting the heat exchanger 20c and the high pressure boiler 13Hc to each other.

The cooling tower introduction pipe 15c connects the cooling tower 12c and the heat exchanger 20c to each other. The drainage water EWc which has been subjected to heat exchange in the heat exchanger 20c is introduced into the cooling tower 12c through the cooling tower introduction pipe 15c (fluid recovery step).

In the thermal power plant 1c described above, even if a part of the water Wc has to be discharged as the drainage water EWc from the circulating boiler 13c through the blow pipe 14c due to the constraints on standards or operation, heat energy of the drainage water EWc can be recovered to the water Wc directed toward the circulating boiler 13c from the condenser 11c by the heat exchanger 20c without wasting it to the outside of the system. Further, the water Wc from the condenser 11c can be preheated by the heat energy of the drainage water EWc discharged through the blow pipe 14c and can be introduced into the high pressure boiler 13Hc.

Therefore, the heat efficiency of the entire circulating boiler system 2c can be improved, and thus power generation efficiency in the thermal power plant 1c can be further improved utilizing exhaust heat.

Here, the level of the water quality required for the water Wc inside the cooling tower 12c may be lower than the level of the water quality generally required for the water Wc inside the circulating boiler 13c. In the present embodiment, the drainage water EWc can be effectively utilized without being discharged to the outside of the system by introducing the drainage water EWc discharged through the blow pipe 14c into the cooling tower 12c after heat exchange in the heat exchanger 20c without returning it to the circulating boiler 13c. Further, the water quality of the water Wc inside the circulating boiler 13c can be maintained in a clean state.

In addition, since the drainage water EWc discharged through the blow pipe 14c is no longer released to the outside of the system while maintaining a high temperature, the influence of heat on facilities outside the system can be reduced. Therefore, there is no need to install a facility for decreasing the temperature of the drainage water EWc discharged through the blow pipe 14c or a processing facility of the drainage water EWc, so that the manufacturing cost of the circulating boiler system 2c can be reduced, and the environmental load can be reduced.

In the present embodiment, the water Wc after heat exchange in the heat exchanger 20c is introduced into the high pressure boiler 13Hc, but it is not limited thereto. For example, the water Wc may be introduced into the medium pressure boiler 131c or the low pressure boiler 13Lc in accordance with the temperature or the pressure thereof after heat exchange.

Moreover, the exhaust gas EGc after passing through the evaporator 32c does not have to be introduced into the heater 26c and the air cooler 27c.

Moreover, in the present embodiment, the water Wc is heated by the evaporator 32c using heat of the exhaust gas EGc in the gas turbine 21c. However, for example, the water Wc may be heated by the evaporator 32c using a different heat source. That is, in this case, the circulating boiler system 2c of the present embodiment may be applied as a heat source other than the gas turbine 21c. Specifically, the circulating boiler system 2c of the present embodiment may also be applied to a conventional coal-burning power plant or the like.

### Thirteenth Embodiment

Next, a thermal power plant 1Ac of a thirteenth embodiment will be described. The same reference signs are applied to constituent elements similar to those of the twelfth embodiment, and detailed description will be omitted.

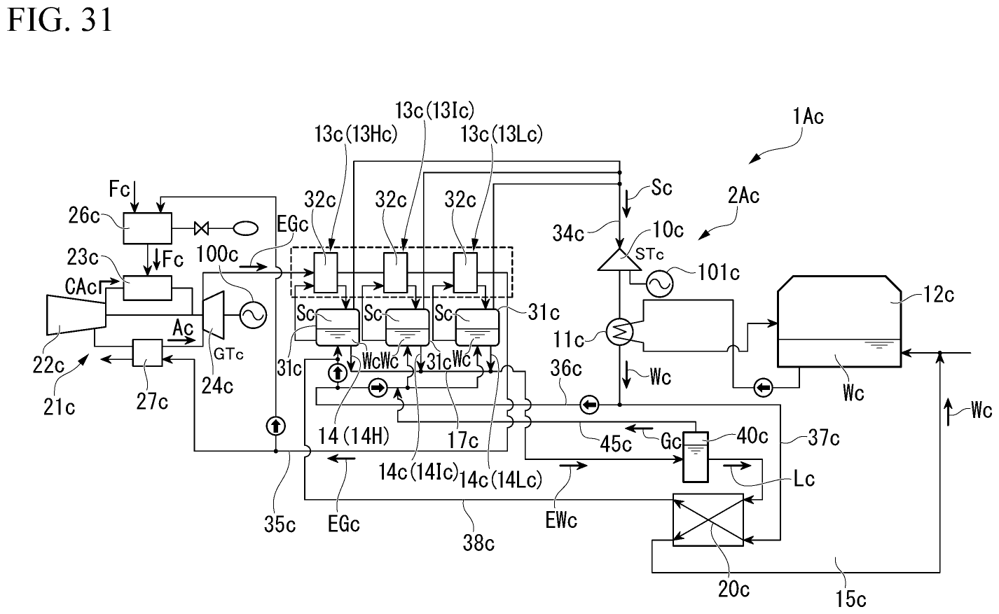

As illustrated in FIG. 31, the thermal power plant 1Ac differs from that of the twelfth embodiment in that a circulating boiler system 2Ac further includes a flash tank 40c provided at an intermediate position of the joining pipe 17c.

The flash tank 40c is provided in the joining pipe 17c between the boiler main body 31c and the heat exchanger 20c. The flash tank 40c reduces the temperature and the pressure of the drainage water EWc from the blow pipe 14c. In addition, the drainage water EWc from the blow pipe 14c connected to the boiler main body 31c of each of the boilers 13c is introduced into the flash tank 40c, and the drainage water EWc is divided into a gas phase Gc and a liquid phase Lc. Further, the liquid phase Lc is introduced into the heat exchanger 20c, and the gas phase Gc is introduced into the boiler main bodies 31c in the medium pressure boiler 131c and the low pressure boiler 13Lc through a gas phase introduction pipe 45c. The introduction place of the gas phase Gc can be suitably changed in accordance with the state of the gas phase Gc.

In the thermal power plant 1Ac of the present embodiment described above, the drainage water EWc discharged through the blow pipe 14c is flashed in the flash tank 40c such that the temperature (approximately 100° C.) and the pressure are lowered. Accordingly, it is possible to avoid backflow of the drainage water EWc when being introduced into the cooling tower. In addition, after impurities are eliminated in the flash tank 40c, the gas phase Gc of the drainage water EWc can return to the circulating boiler 13c. Thus, the supply amount of the makeup water required when the amount of the water We in the circulating boiler 13c has decreased can be reduced by discharging it through the blow pipe 14c. Thus, the cost of the makeup water can be reduced.

### Fourteenth Embodiment

Next, a thermal power plant 1Bc of a fourteenth embodiment will be described. The same reference signs are applied to constituent elements similar to those of twelfth embodiment and the thirteenth embodiment, and detailed description will be omitted.

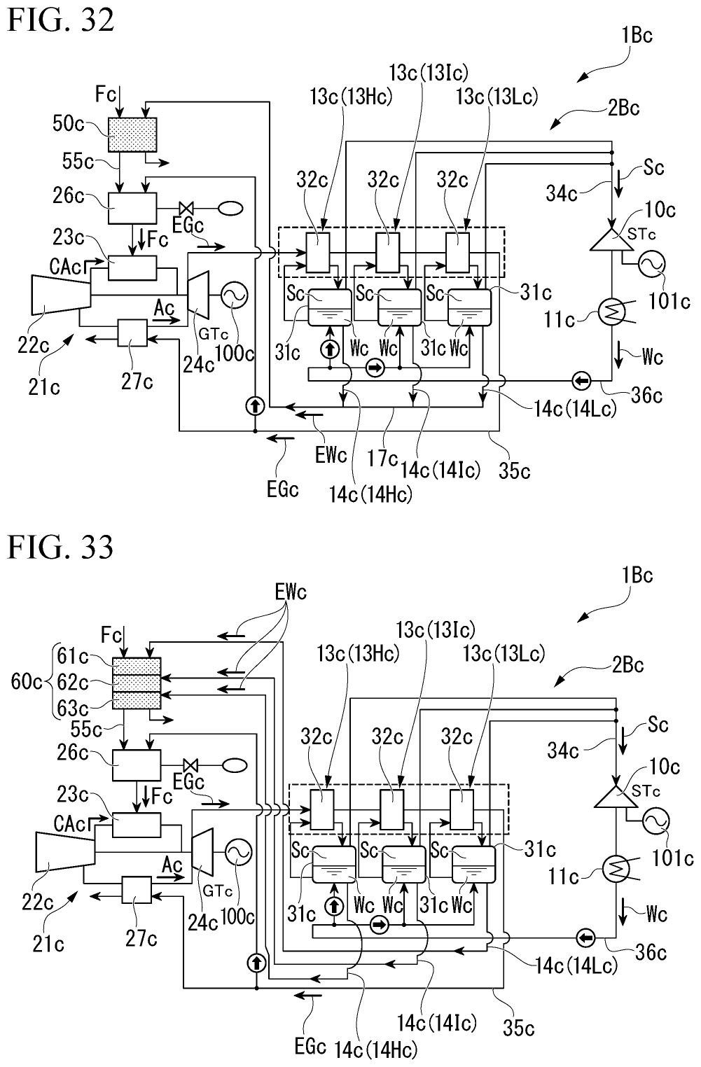

As illustrated in FIG. 32, the thermal power plant 1Bc differs from those of the twelfth embodiment and the thirteenth embodiment in that a circulating boiler system 2Bc includes a heat exchanger 50c in place of the heat exchanger 20c and does not include the cooling tower 12c.

The heat exchanger 50c is connected to each of the blow pipes 14c through the joining pipe 17c. Accordingly, the drainage water EWc from each of the blow pipes 14c is collectively introduced into the heat exchanger 50c. In addition, the fuel Fc in the gas turbine 21c is introduced into the heat exchanger 50c. Further, heat exchange is performed between the drainage water EWc and the fuel Fc, so that the drainage water EWc is cooled and the fuel Fc is heated through heat recovery in the fuel Fc (exhaust heat recovery step). The drainage water EWc cooled in the heat exchanger 50c is discharged to the outside of the system.

Moreover, the heat exchanger 50c and the heater 26c are connected to each other through a fuel introduction pipe 55c. The fuel Fc heated by the heat exchanger 50c is introduced into the heater 26c through the fuel introduction pipe 55c and is further heated therein.

In the thermal power plant 1Bc of the present embodiment described above, the heat energy of the drainage water EWc discharged from each of the boilers 13c through each of the blow pipes 14c can be recovered to the fuel Fc in the gas turbine 21c by the heat exchanger 50c without wasting it to the outside of the system. Further, the fuel Fc can be introduced into the combustor 23c through the heater 26c in a state where the fuel Fc in the gas turbine 21c is preheated using the heat energy of the drainage water EWc discharged through the blow pipe 14c. Therefore, the heat efficiency of the entire plant can be improved.

In addition, the drainage water EWc from the blow pipe 14c is discharged to the outside of the system after being cooled by the heat exchanger 50c. However, the temperature of the drainage water EWc is relatively low. Therefore, even if the drainage water EWc is discharged to the outside of the system, there is no need to have a facility for decreasing the temperature of the drainage water EWc, so that the manufacturing cost of the system can be reduced, and the environmental load can be reduced.

Here, as illustrated in FIG. 33 in the present embodiment, a heat exchanger 60c may have a low temperature stage 61c, a medium temperature stage 62c, and a high temperature stage 63c from the upstream side toward the downstream side of a flow of the fuel Fc. Further, in the example of FIG. 33, the joining pipe 17c is not provided, and the low pressure blow pipe 14Lc is directly connected to the low temperature stage 61c such that the drainage water EWc from the low pressure blow pipe 14Lc is introduced thereinto. In addition, the medium pressure blow pipe 141c is directly connected to the medium temperature stage 62c such that the drainage water EWc from the medium pressure blow pipe 141c is introduced thereinto. The high pressure blow pipe 14Hc is directly connected to the high temperature stage 63c such that the drainage water EWc from the high pressure blow pipe 14Hc is introduced thereinto.

The temperature of the drainage water EWc from the boiler main body 31c in each of the boilers 13c differs from those of from other boilers 13c. In the example of FIG. 33, since each stage of the heat exchanger 60c is provided in accordance with the temperature level of the drainage water EWc, the fuel Fc can be efficiently heated in stages using the heat energy of the drainage water EWc.

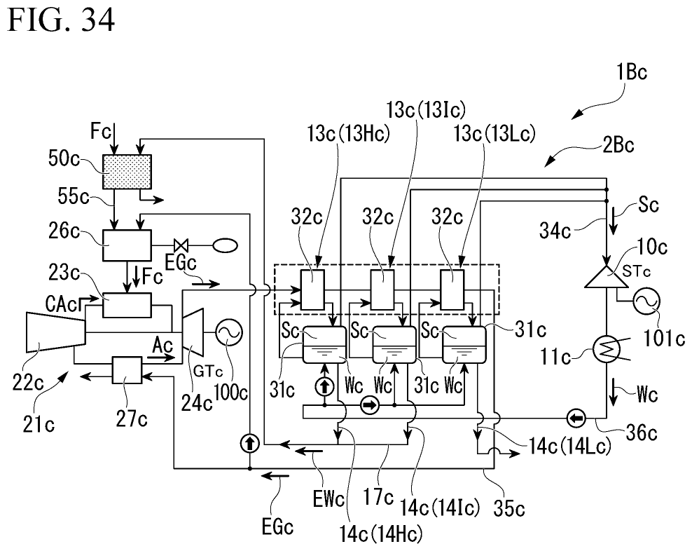

In addition, in the present embodiment as illustrated in FIG. 34, the joining pipe 17c connects the high pressure blow pipe 14Hc and the medium pressure blow pipe 14Lc to each other and does not have to be connected to the low pressure blow pipe 14Lc. Further, in this case, the drainage water EWc from the high pressure blow pipe 14Hc and the medium pressure blow pipe 14Lc is collectively introduced into the heat exchanger 50c and heats the fuel Fc. The drainage water EWc from the low pressure blow pipe 14Lc is discharged to the outside of the system.

In the example of FIG. 34, the heat energy of the drainage water EWc from the low pressure blow pipe 14Lc at a relatively low temperature (with low enthalpy) is not recovered in the fuel Fc, and only the heat energy of the drainage water EWc from the high pressure blow pipe 14Hc and the medium pressure blow pipe 141c at a relatively high temperature (with high enthalpy) is recovered in the fuel Fc. Therefore, the fuel Fc can be preheated efficiently. Only the heat energy of the drainage water EWc from the high pressure blow pipe 14Hc may be recovered in the fuel Fc.

### Fifteenth Embodiment

Next, a thermal power plant 1Cc of a fifteenth embodiment will be described. The same reference signs are applied to constituent elements similar to those of the twelfth embodiment to the fourteenth embodiment, and detailed description will be omitted.

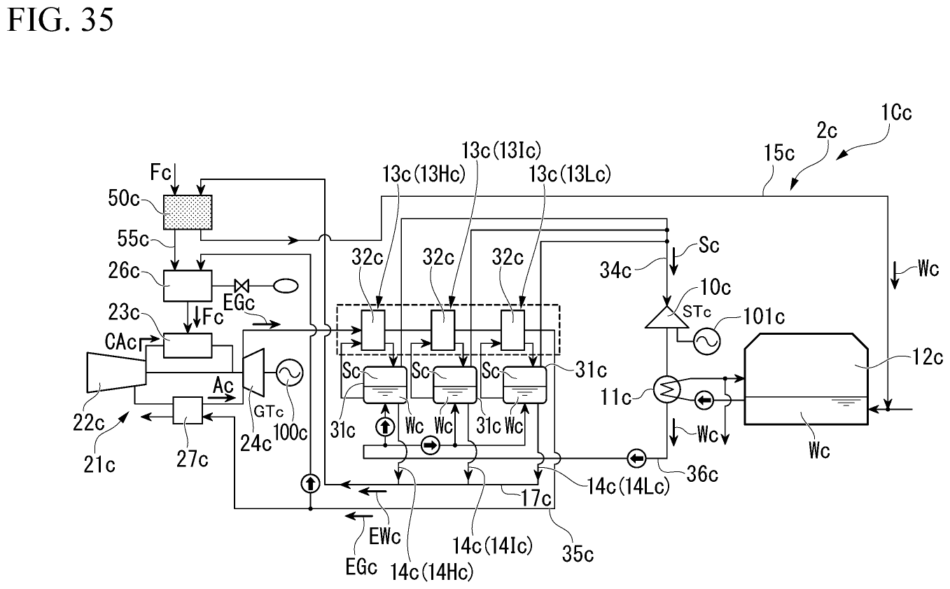

As illustrated in FIG. 35, the thermal power plant 1Cc differs from that of the fourteenth embodiment in that a circulating boiler system 2Cc further includes the cooling tower 12c and the cooling tower introduction pipe 15c.

The cooling tower introduction pipe 15c connects the cooling tower 12c and the heat exchanger 50c to each other. The drainage water EWc which has been cooled after heat exchange with the fuel Fc in the heat exchanger 50c is introduced into the cooling tower 12c through the cooling tower introduction pipe 15c (fluid recovery step).

In the thermal power plant 1Cc of the present embodiment described above, the drainage water EWc discharged through the blow pipe 14c is introduced into the cooling tower 12c after heat exchange in the heat exchanger 50c without returning to the circulating boiler 13c, so that the drainage water EWc can be utilized effectively without being discharged to the outside of the system, and thus the water quality of the water Wc inside the circulating boiler 13c can be maintained in a clean state.

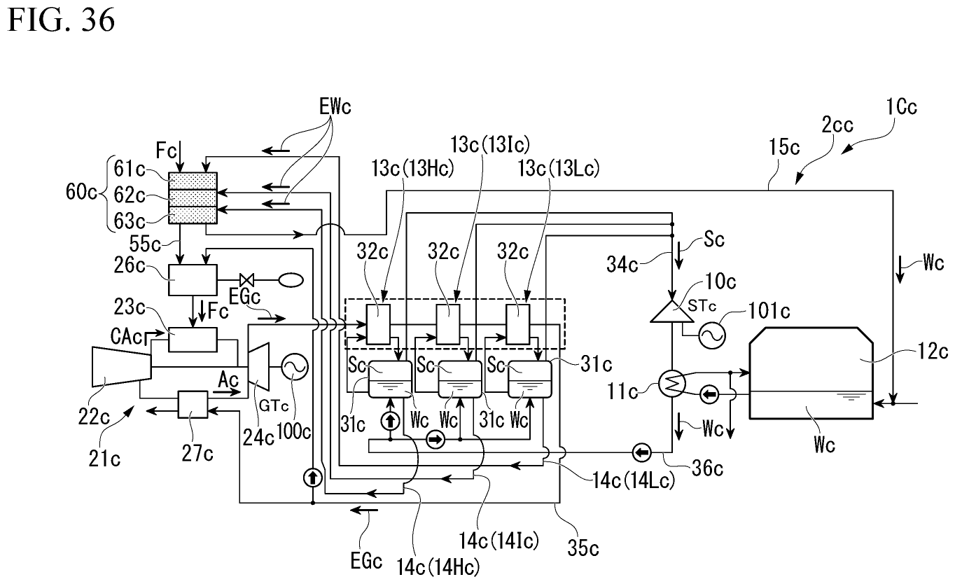

Here, as illustrated in FIG. 36, in the present embodiment as well, in the same manner as the example of the fourteenth embodiment illustrated in FIG. 33, the heat exchanger 60c may have the low temperature stage 61c, the medium temperature stage 62c, and the high temperature stage 63c.

Hereinabove, some embodiments have been described in detail with reference to the drawings. However, each of the constitutions, combinations thereof, and the like in each of the embodiments are merely examples, and the constitutions can be subjected to addition, omission, replacement, and other changes within a range not departing from the gist of the present invention. In addition, the present invention is not limited by the embodiments and is limited by only the claims.

For example, in each of the embodiments described above, three circulating boilers 13c are provided. However, the number of circulating boilers 13c is not limited to three. One or two circulating boilers may be adopted, or four or more circulating boilers may be adopted.

In addition, in place of the steam turbine 10c, a low boiling point element Rankine cycle having a low boiling point element turbine in which a low boiling point element whose boiling point is lower than that of the water Wc is used as an operation fluid may also be applied to the embodiments described above. Here, as the low boiling point element, for example, the following substances are known.
Organic halogen compounds such as trichlorethylene, tetrachloroethylene, monochlorobenzene, dichlorobenzene, and perfluorodecalin
Alkane such as butane, propane, pentane, hexane, heptane, octane, and decane
Cyclic alkane such as cyclopentane and cyclohexane
Thiophene, ketone, and aromatic compounds
Refrigerants such as R134a and R245fa
Combinations of those listed above

In this case, the low boiling point element is also used as a fluid circulating between the cooling tower 12c and the condenser 11c.

In addition, the capacities of the heat exchanger 20c, the heat exchanger 50c, and the heat exchanger 60c may be designed in accordance with the temperature of the water We returning to the cooling tower 12c.

In addition, when the heat exchange amounts in the heat exchanger 20c, the heat exchanger 50c, and the heat exchanger 60c become excessively large, the flow rate of the drainage water EWc introduced into the heat exchanger 20c, the heat exchanger 50c, and the heat exchanger 60c may be adjusted by providing a bypass line.

<Constitution of Computer>

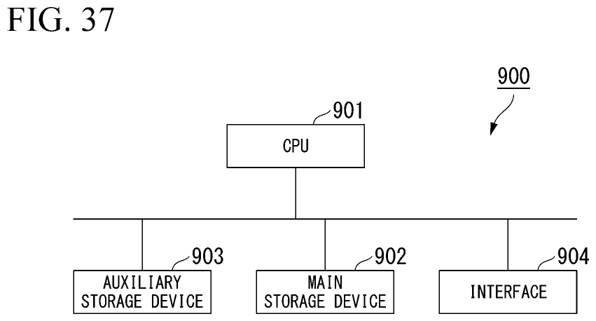

FIG. 37 is a schematic block diagram illustrating a constitution of a computer according to at least one embodiment.

A computer 900 includes a CPU 901, a main storage device 902, an auxiliary storage device 903, and an interface 904.

At least one of the chemical feed control device 110, the chemical management device 200, the auxiliary-machine control device 110a, and the state-evaluating device 110b described above is mounted in the computer 900. Further, operation of each of the processing units described above is stored in the auxiliary storage device 903 in a form of a program. The CPU 901 reads the program from the auxiliary storage device 903 and deploys the program in the main storage device 902, thereby executing the processing in accordance with the program. In addition, the CPU 901 secures a storage domain corresponding to each of the storage units described above in the main storage device 902 and the auxiliary storage device 903 in accordance with the program.

Examples of the auxiliary storage device 903 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory. The auxiliary storage device 903 may be an internal media directly connected to a bus of the computer 900 or may be an external media connected to the computer 900 via the interface 904 or a communication line. In addition, when this program is distributed to the computer 900 through a communication line, the computer 900 to which the program is distributed may deploy the program in the main storage device 902 and execute the processing. In at least one embodiment, the auxiliary storage device 903 is a physical storage medium, which is not a temporary storage medium.

In addition, the program may realize a part of the functions described above. Moreover, the program may realize the functions described above in a combination with other programs which are already stored in the auxiliary storage device 903, or may be a so-called differential file (differential program).

In addition, the present invention is not limited to the embodiments described above and may be a combination of constitutions according to a plurality of embodiments.

### INDUSTRIAL APPLICABILITY

According to a chemical feed control device, a feed amount of components constituting a chemical can be rationalized by determining the feed amounts of a plurality of chemicals having different components in accordance with a water quality.

### REFERENCE SIGNS LIST

110 Chemical feed control device
1101 Water quality index value-obtaining unit
1102 Environmental data-obtaining unit
1103 Operational data-obtaining unit
1104 Model storage unit
1105 Determination unit
1106 Control unit
1107 Updating unit
1108 Cost storage unit
1109 Candidate determination unit
1110 Cost determination unit
1111 Standard cost determining unit

1. A chemical feed control device which controls feeding of a chemical into a water system of a plant, the chemical feed control device comprising:
a water quality index-obtaining unit that obtains a water quality index value for each of a plurality of disruptive factors of the water system;
an environmental data-obtaining unit that obtains environmental data related to the plant;
an operational data-obtaining unit that obtains operational data related to the plant;
a model storage unit that stores a chemical feed model;
a determination unit that determines a feed amount of each of a plurality of chemicals acting on at least one of the disruptive factors and having components different from each other with respect to the water system based on the water quality index value, the environmental data, and the operational data such that the water quality index value for each of the disruptive factors approximates a water quality target value for each of the disruptive factors; and
a control unit that outputs a command of feeding the chemicals into the water system based on the feed amount,
wherein the chemical feed model is generated through machine learning based on a relationship between input data and output data when the water quality index value, the environmental data, and the operational data are the input data and the feed amount is the output data, and a constraint penalty value based on a constraint including a combination of prohibited chemicals.

2-3. (canceled)

4. The chemical feed control device according to claim 1, wherein at least one of the plurality of chemicals acts on the plurality of disruptive factors of the water system.

5. The chemical feed control device according to claim 1, wherein the determination unit determines the feed amount of each of the plurality of chemicals such that costs are reduced.

6. The chemical feed control device according to claim 5, further comprising:
a candidate determination unit that determines a plurality of candidates for the feed amount of each of the plurality of chemicals based on water quality; and
a cost determination unit that determines the cost of each of the plurality of candidates determined by the candidate determination unit, based on a unit cost which is a cost per unit feed amount of each of the chemicals,
wherein the determination unit determines a candidate, of the plurality of candidates, having a lowest cost as the feed amount of each of the plurality of chemicals.

7. The chemical feed control device according to claim 6, further comprising:
a standard cost determining unit that determines a standard cost regarding a plurality of target water qualities based on a preset cost model indicating a relationship between an improvement factor of the water quality and the standard cost of the chemicals,
wherein the candidate determination unit determines the plurality of candidates for the feed amount of each of the plurality of chemicals for each of the target water qualities based on the water quality, and
wherein the determination unit determines a candidate, of the plurality of candidates, having a largest value when the cost determined by the cost determination unit is subtracted from the standard cost determined by the standard cost determining unit as the feed amount of each of the plurality of chemicals.

8. The chemical feed control device according to claim 1, wherein the determination unit determines the feed amount of each of the plurality of chemicals such that an amount of the component acting on each of the plurality of disruptive factors becomes a necessary minimum.

9. The chemical feed control device according to claim 1, wherein the plurality of disruptive factors include corrosion, scaling, and fouling of the water system.

10. A water treatment system comprising:
a water system;
a plurality of chemical tanks that retain chemicals having different components;
a plurality of chemical feed pumps that supply the chemicals retained respectively in the plurality of chemical tanks to the water system; and
the chemical feed control device according to claim 1.

11. A chemical feed control method for controlling feeding of a chemical into a water system of a plant, the chemical feed control method comprising:
a step of obtaining a water quality index value for each of a plurality of disruptive factors of the water system;
a step of obtaining environmental data related to the plant;
a step of obtaining operational data related to the plant;
a step of determining a feed amount of each of a plurality of chemicals acting on at least one of the disruptive factors and having components different from each other with respect to the water system based on the water quality index value, the environmental data, the operational data, and a chemical feed model such that the water quality index value for each of the disruptive factors approximates a water quality target value for each of the disruptive factors; and
a step of outputting a command of feeding the chemicals into the water system based on the feed amount,
wherein the chemical feed model is generated through machine learning based on a relationship between input data and output data when the water quality index value, the environmental data, and the operational data are the input data and the feed amount is the output data, and a constraint penalty value based on a constraint including a combination of prohibited chemicals.

12. A program for causing a computer of a chemical feed control device which controls feeding of a chemical into a water system of a plant to execute:
a step of obtaining a water quality index value for each of a plurality of disruptive factors of the water system;
a step of obtaining environmental data related to the plant;
a step of obtaining operational data related to the plant; and
a step of determining a feed amount of each of a plurality of chemicals acting on at least one of the disruptive factors and having components different from each other with respect to the water system based on the water quality index value, the environmental data, the operational data, and a chemical feed model such that the water quality index value for each of the disruptive factors approximates a water quality target value for each of the disruptive factors; and
a step of outputting a command of feeding the chemicals into the water system based on the feed amount,
wherein the chemical feed model is generated through machine learning based on a relationship between input data and output data when the water quality index value, the environmental data, and the operational data are the input data and the feed amount is the output data, and a constraint penalty value based on a constraint including a combination of prohibited chemicals.

13. A chemical management device which determines a purchasing volume of a chemical to be fed into a water system of a plant, the chemical management device comprising:
a predicted environmental data-obtaining unit that obtains a prediction value of environmental data related to the plant during a specific period;
an operation plan-obtaining unit that obtains an operation plan of the plant during the specific period;
a water quality index prediction unit that predicts a water quality index value of the water system during the specific period;
a chemical amount prediction unit that predicts a change in used amount of each of a plurality of chemicals acting on at least one of the disruptive factors during the specific period and having components different from each other based on the prediction value of the environmental data, the operation plan, and the predicted water quality index value; and
a determination unit that determines the purchasing volume of each of the plurality of chemicals based on the predicted change in used amount of the chemicals such that a purchasing cost of the chemicals is reduced.

14. The chemical management device according to claim 13,
wherein the chemical amount prediction unit further predicts a change in storage amount of the chemicals during the specific period, and
wherein the determination unit determines the purchasing volume of each of the plurality of chemicals such that the purchasing cost of the chemicals is reduced and the storage amount of the chemicals does not exceed an allowable storage amount.

15. The chemical management device according to claim 13, wherein the determination unit determines the purchasing volume and a purchasing timing of each of the plurality of chemicals such that the purchasing cost of the chemicals is reduced.
